(19) United States
(12) Patent Application Publication
(10) Pub. No.: US 2014/0180738 A1
(43) Pub. Date: Jun. 26, 2014

(54) MACHINE LEARNING FOR SYSTEMS MANAGEMENT

(71) Applicant: CLOUDVU, INC., Sandy, UT (US)

(72) Inventors: Kelly D. Phillipps, Salt Lake City, UT (US); Richard W. Wellman, Park City, UT (US); Milind D. Zodge, MIdvale, UT (US); Bradley W. Jones, Centerville, UT (US)

(73) Assignee: CLOUDVU, INC., Sandy, UT (US)

(21) Appl. No.: 13/725,995

(22) Filed: Dec. 21, 2012

(51) Int. Cl. G06N 99/00

(52) U.S. Cl. CPC G06N 99/005; G06Q 10/0631
USPC 705/7.12; 706/12; 705/7.38

(57) ABSTRACT

An apparatus, system, method, and computer program product are disclosed for systems management. The method includes receiving user information and systems management data as machine learning inputs. The user information labels a state of one or more computing resources. The method includes recognizing a pattern, using machine learning, in the systems management data. The method includes modifying a configuration of a systems management system based on the labeled state and the recognized pattern.

### TECHNICAL FIELD

The present disclosure, in various embodiments, relates to systems management and more particularly relates to modifying a systems management system using machine learning.

### BACKGROUND

Systems management systems, also referred to as enterprise management systems, are often used to administer and monitor enterprise computer systems. These systems management systems typically have hundreds or thousands of settings, rules, and thresholds. The defaults for these settings, rules, and thresholds may be inaccurate and typically are not customized or tailored to a specific set of computer systems. Because of inaccurate settings, rules, and thresholds, many systems management systems provide inaccurate results, excessive amounts of unnecessary information, or irrelevant information and can fall into disuse over time.

Even if an alert or result of a systems management system is accurate, the alert may not reach a person most suitable to address the problem. A large percentage of downtime associated with enterprise computer systems may be attributable to finding the correct systems administrator or other person to diagnose and fix the problem.

### SUMMARY

From the foregoing discussion, it should be apparent that a need exists for an apparatus, system, method, and computer program product for modifying and adjusting a configuration of a systems management system. Beneficially, such an apparatus, system, method, and computer program product would use machine learning to modify inaccurate settings, rules, and/or thresholds for a systems management system in an automated manner.

The present disclosure has been developed in response to the present state of the art, and in particular, in response to the problems and needs in the art that have not yet been fully solved by currently available systems management systems. Accordingly, the present disclosure has been developed to provide an apparatus, system, method, and computer program product for modifying a systems management system that overcome many or all of the above-discussed shortcomings in the art.

A method for systems management is presented. In one embodiment, the method includes receiving user information and systems management data as machine learning inputs. The user information, in certain embodiments, labels a state of one or more computing resources. The method, in a further embodiment, includes recognizing a pattern, using machine learning, in the systems management data. In another embodiment, the method includes modifying a configuration of a systems management system based on the labeled state and the recognized pattern.

Modifying the configuration of the systems management system, in various embodiments, may include adding a rule, removing a rule, modifying an existing rule, setting a threshold, and/or intercepting an alert from the systems management system. The method, in one embodiment, may include limiting an amount of modifications to the configuration of the systems management system so that the amount of modifications satisfies a performance threshold.

The user information, in one embodiment, includes an indication of whether an alert from the systems management system accurately identifies the state of the one or more computing resources. In a further embodiment, the user information includes a set of user classifications labeling one or more values of a performance metric for a business activity to label the state of the one or more computing resources.

The machine learning, in one embodiment, includes a machine learning ensemble comprising a plurality of learned functions from multiple classes. The plurality of learned functions, in certain embodiments, is selected from a larger plurality of generated learned functions. The systems management data, in various embodiments, may include application log data, a monitored hardware statistic, a processor usage metric, a volatile memory usage metric, a storage device metric, a performance metric for a business activity, an identifier of an executing thread, a network event, a network metric, a transaction duration, a user sentiment indicator, a weather status for a geographic area of the one or more computing resources, or the like.

A computer program product comprising a computer readable storage medium storing computer usable program code executable to perform operations for systems management is presented. In one embodiment, the operations include receiving user information and incident management data as machine learning inputs. The user information, in certain embodiments, labels a state of one or more computing resources. The operations, in another embodiment, include recognizing an incident in systems management data for the one or more computing resources based on the user information. In a further embodiment, the operations include determining a destination for an incident management alert based on a pattern identified in the incident management data using machine learning.

The incident management data, in one embodiment, comprises a history of incident management alert destinations and/or incident outcomes. The operations, in certain embodiments, include monitoring subsequent incident management data, using the machine learning. In another embodiment, the operations include determining a different destination for a subsequent incident management alert for a similar incident based on the subsequent incident management data. The machine learning, in one embodiment, includes a machine learning ensemble comprising a plurality of learned functions from multiple classes. In certain embodiments, the plurality of learned functions is selected from a larger plurality of pseudo-randomly generated learned functions.

An apparatus for systems management is presented. In one embodiment, an input module is configured to receive systems management data. A machine learning ensemble, in a further embodiment, comprises a plurality of learned functions from multiple classes. In certain embodiments, the plurality of learned functions is selected from a larger plurality of generated learned functions. The machine learning ensemble, in another embodiment, is configured to recognize a pattern in the systems management data. In one embodiment, a result module is configured to modify a configuration of a systems management system based on the recognized pattern.

An ensemble factory module, in certain embodiments, is configured to form the machine learning ensemble. The ensemble factory module, in a further embodiment, is configured to generate the larger plurality of generated learned functions using training systems management data. In one embodiment, the ensemble factory module is configured to select the plurality of learned functions based on an evaluation of the larger plurality of learned functions using test systems management data. The ensemble factory module, in another embodiment, is configured to combine multiple learned functions from the larger plurality of generated learned functions to form a combined learned function for the plurality of learned functions of the machine learning ensemble. In another embodiment, the ensemble factory module is configured to add one or more layers to at least a portion of the larger plurality of generated learned functions to form one or more extended learned functions for the plurality of learned functions of the machine learning ensemble. In certain embodiments, the apparatus includes one or more additional machine learning ensembles. Each machine learning ensemble, in a further embodiment, is associated with a different set of one or more rules of the systems management system.

A method is presented for systems management. The method, in one embodiment, includes identifying a business activity based on input from a user. In a further embodiment, the method includes recognizing one or more patterns, using machine learning, in systems management data for a plurality of computing resources. The method, in another embodiment, includes associating the identified business activity with one or more of the computing resources, using machine learning, based on the recognized one or more patterns.

In one embodiment, the method includes modifying a systems management system based on the one or more recognized patterns. The systems management system, in certain embodiments, is associated with the plurality of computing resources. The method, in another embodiment, includes providing a capacity projection for at least one of the plurality of computing resources based on the recognized one or more patterns. The capacity projection, in certain embodiments, comprises an estimate of an effect of adjusting a capacity of the at least one computing resource. In a further embodiment, the capacity projection comprises a prediction of an incident associated with a capacity of the at least one computing resource.

The method, in another embodiment, includes monitoring the systems management data and a performance metric associated with the business activity, using the machine learning, to recognize one or more additional patterns associated with the identified business activity. The input from the user, in one embodiment, comprises a set of classifications for a performance metric associated with the business activity. Each classification in the set, in certain embodiments, labels one or more possible values of the performance metric for the business activity. The performance metric, in a further embodiment, comprises an amount of time to complete the business activity and/or a volume of transactions associated with the business activity.

Another computer program product is presented, comprising a computer readable storage medium storing computer usable program code executable to perform operations for systems management. The operations, in one embodiment, include receiving user information and systems management data as machine learning inputs. The user information, in certain embodiments, identifies a state of one or more computing resources. The operations, in another embodiment, include recognizing a pattern, using machine learning, in the systems management data. In a further embodiment, the operations include predicting an incident for the one or more computing resources based on the identified state and the recognized pattern.

The operations, in one embodiment, include determining a destination for an incident management alert for the predicted incident based on historical incident management data. The operations, in a further embodiment, include modifying a configuration of a systems management system based on the predicted incident. The pattern, in one embodiment, comprises a precursor state for the incident. The user information, in another embodiment, identifies which of the one or more computing resources are associated with an identified business transaction. The machine learning, in certain embodiments, includes a machine learning ensemble comprising a plurality of learned functions from multiple classes, the plurality of learned functions selected from a larger plurality of generated learned functions.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

Furthermore, the described features, advantages, and characteristics of the disclosure may be combined in any suitable manner in one or more embodiments. The disclosure may be practiced without one or more of the specific features or advantages of a particular embodiment. In other instances, additional features and advantages may be recognized in certain embodiments that may not be present in all embodiments of the disclosure.

These features and advantages of the present disclosure will become more fully apparent from the following description and appended claims, or may be learned by the practice of the disclosure as set forth hereinafter.

### BRIEF DESCRIPTION OF THE DRAWINGS

In order that the advantages of the disclosure will be readily understood, a more particular description of the disclosure briefly described above will be rendered by reference to specific embodiments that are illustrated in the appended drawings. Understanding that these drawings depict only typical embodiments of the disclosure and are not therefore to be considered to be limiting of its scope, the disclosure will be described and explained with additional specificity and detail through the use of the accompanying drawings, in which:

FIG. 1 is a schematic block diagram illustrating one embodiment of a system for modifying a systems management system;

FIG. 2A is a schematic block diagram illustrating one embodiment of a machine learning module;

FIG. 2B is a schematic block diagram illustrating another embodiment of a machine learning module;

FIG. 3 is a schematic block diagram illustrating one embodiment of an ensemble factory module;

FIG. 4 is a schematic block diagram illustrating one embodiment of a system for an ensemble factory;

FIG. 5 is a schematic block diagram illustrating one embodiment of learned functions for a machine learning ensemble;

FIG. 6 is a schematic flow chart diagram illustrating one embodiment of a method for an ensemble factory;

FIG. 7 is a schematic flow chart diagram illustrating another embodiment of a method for an ensemble factory;

FIG. 8 is a schematic flow chart diagram illustrating one embodiment of a method for directing data through a machine learning ensemble;

FIG. 9 is a schematic flow chart diagram illustrating one embodiment of a method for modifying a systems management system;

FIG. 10 is a schematic flow chart diagram illustrating one embodiment of a method for modifying an incident management system;

FIG. 11 is a schematic flow chart diagram illustrating one embodiment of a method for systems management; and

FIG. 12 is a schematic flow chart diagram illustrating one embodiment of a method for incident prediction.

### DETAILED DESCRIPTION

Aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable storage media having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable storage media.

Any combination of one or more computer readable storage media may be utilized. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), a blu-ray disc, an optical storage device, a magnetic tape, a Bernoulli drive, a magnetic disk, a magnetic storage device, a punch card, integrated circuits, other digital processing apparatus memory devices, or any suitable combination of the foregoing, but would not include propagating signals. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including an object oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the disclosure may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the disclosure. However, the disclosure may be practiced without one or more of the specific details, or with other methods, components, materials, and so forth. In other instances, well-known structures, materials, or operations are not shown or described in detail to avoid obscuring aspects of the disclosure.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

The description of elements in each figure may refer to elements of proceeding figures. Like numbers refer to like elements in all figures, including alternate embodiments of like elements.

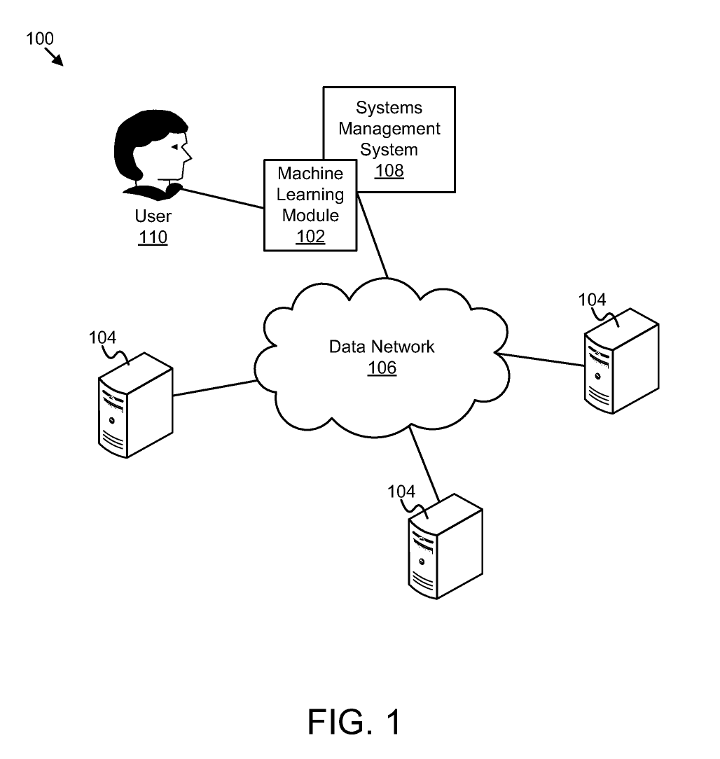

FIG. 1 depicts one embodiment of a system 100 for modifying a systems management system 108. The system 100, in the depicted embodiment, includes a machine learning module 102 configured to adjust, manage, optimize, or otherwise modify rules, settings, thresholds, and/or alerts of the systems management system 108 using machine learning. The machine learning module 102 and/or the systems management system 108, in the depicted embodiment, may be in communication with several computing systems 104 over a data network 106.

The systems management system 108, in general, comprises software and/or hardware configured to administer, monitor, configure, or otherwise manage computing resources of the system 100. A computing resource, in various embodiments, may include a computing system 104, a component of a computing system 104 (e.g., a processor, volatile memory, a nonvolatile storage device, a network interface or host adapter, a graphics processing unit or other graphics hardware, a power supply, or the like), a network device of the data network 106 (e.g., a router, switch, bridge, gateway, hub, repeater, network-attached storage or NAS, proxy server, firewall, or the like), a software application or other computer executable code executing on a computing system (e.g., a server application, a database application, an operating system, a device driver, security or anti-virus software, or the like).

The systems management system 108, in certain embodiments, may comprise an enterprise management system, an application performance management system, a configuration management system, a performance monitoring system, an incident management system, a business activity monitoring system, a business transaction management system, a network management system, or the like. Examples of systems management systems 108 may include Foglight® products from Dell, Inc. of Round Rock, Tex.; OpenView® products from Hewlett-Packard Co. of Palo Alto, Calif.; Oracle Enterprise Manager from Oracle Corp. of Redwood City, Calif.; System Center Configuration Manager from Microsoft, Corp. of Redmond, Wash.; Tivoli Management Framework from International Business Machines Corp. of Armonk, N.Y.; ZENWorks® products from Novell, Inc. of Provo, Utah; Patrol® from BMC Software, Inc. of Houston, Tex.; or the like.

The systems management system 108, in certain embodiments, may monitor systems management data for computing resources, computing systems 104, or the like of the system 100, allowing the systems management system 108 to manage the system 100, provide alerts to users 110, or the like. Systems management data, as used herein, comprises information, indicators, metrics, statistics, or other data associated with the system 100, a computing device 104 or computing resource, a user 110, or the like. For example, in various embodiments, systems management data may include application log data, a monitored hardware statistic, a processor usage metric, a volatile memory usage metric, a storage device metric, a performance metric for a business activity, an identifier of an executing thread, a network event, a network metric, a transaction duration, a user sentiment indicator, a weather status for a geographic area of the one or more computing resources, or the like.

The machine learning module 102 may be integrated with, co-located with, or otherwise in communication with the systems management system 108. For example, the machine learning module 102 may execute on the same host computing device 104 as the systems management system 108 and may communicate with the systems management system 108 using an API, a function call, a shared library, a configuration file, a hardware bus or other command interface, or using another local channel. In another embodiment, the machine learning module 102 may be in communication with the system management system 108 over the data network 106, such as a local area network (LAN), a wide area network (WAN) such as the Internet as a cloud service, a wireless network, a wired network, or another data network 106.

The machine learning module 102, in one embodiment, may comprise computer executable code installed on a computing system 104 for modifying and configuring the systems management system 108. In a further embodiment, the machine learning module 102 may comprise a dedicated hardware device or appliance in communication with the systems management system 108 over the data network 106, over a communications bus, or the like.

In certain embodiments, the systems management system 108 comprises a plurality of rules, settings, thresholds, or the like relating to computing systems 104 or other computing resources. The rules, settings, and/or thresholds may define conditions or states of the system 100 (e.g., the computing systems 104 and/or other computing resources) that trigger the systems management system 108 to perform an action, such as alerting a user 110, reconfiguring a computing system 104 or other computing resource, logging an event, or the like. Default values, however, for the rules, settings, and/or thresholds of the systems management system 108 may be inaccurate, excessive, irrelevant, or otherwise incorrectly configured. Additionally, it may be difficult or unreasonable for a user 110 to define or adjust each rule, setting, and/or threshold for the systems management system 108 manually.

The machine learning module 102, in certain embodiments, interfaces with the systems management system 108 to modify a configuration of the systems management system 108 using machine learning. The machine learning module 102, in one embodiment, uses various data as machine learning inputs. The machine learning module 102 may process systems management data, as described above, as a machine learning input. In one embodiment, the machine learning module 102 may receive systems management data from the systems management system 108, either directly or indirectly, that the systems management system 108 has collected, processed, or the like. In another embodiment, the machine learning module 102 may collect systems management data independently from the systems management system 108, either to supplement systems management data from the systems management system 108 or in place of systems management data from the systems management system 108.

In one embodiment, the machine learning module 102 receives information from a user 110 as a machine learning input. The machine learning module 102 may receive user information labeling or other identifying a state of one or more computing systems 104 or other computing resources, as an indication of whether an alert from the systems management system 108 is accurate or the like. For example, a user 110 may label or identify a state with one or more predefined state indicators (e.g., good/bad, satisfactory/unsatisfactory, positive/negative, or the like). The machine learning module 102 may provide an interface for a user 110 to label a state of the system 100 in response to an alert or other action by the systems management system 108.

In another embodiment, a user 110 may provide the machine learning module 102 with information identifying a business action. A business action, as used herein, comprises a transaction or other event executed or performed by one or more computing resources. For example, a business action may include a web server transaction, an application server transaction, a database transaction, execution of predefined computer executable program code, a function call, or the like. A business action may be triggered by or visible to a user 110. The machine learning module 102, using machine learning, based on user input, or the like, may associate the identified business action with one or more computing systems 104 or other computing resources. The machine learning module 102 may monitor performance of an identified business action using machine learning, such that the performance of the business action labels a state of the system 100, one or more computing systems 104 or other computing resources, or the like.

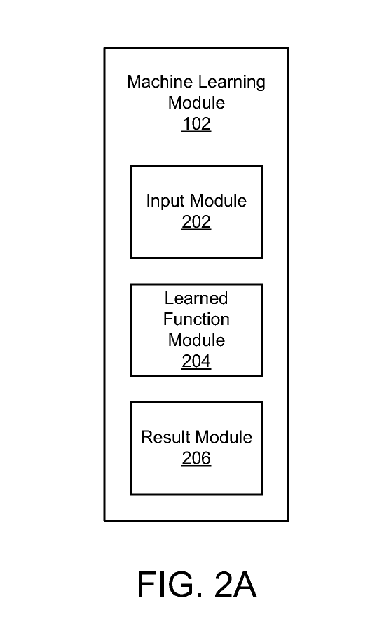

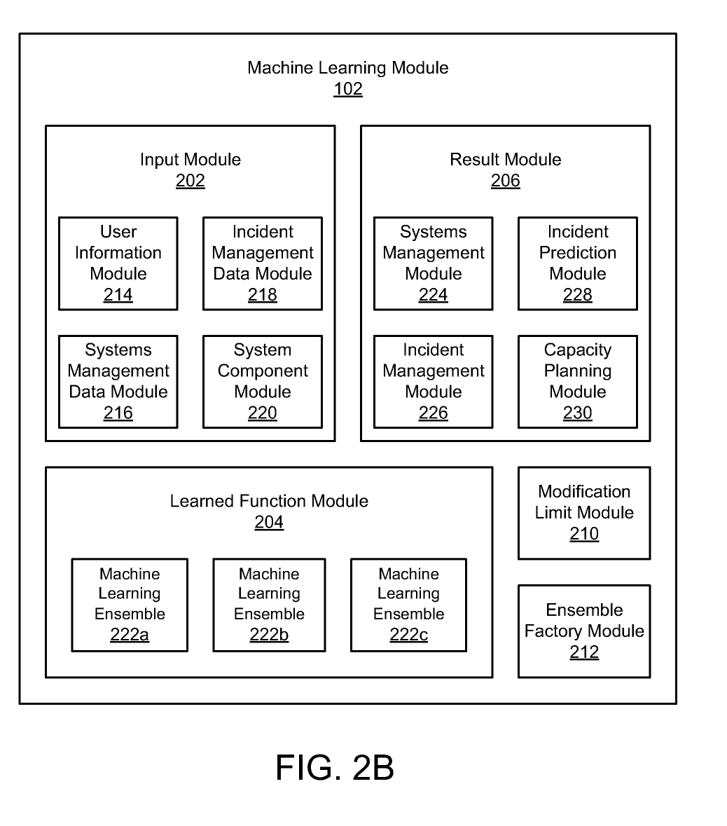

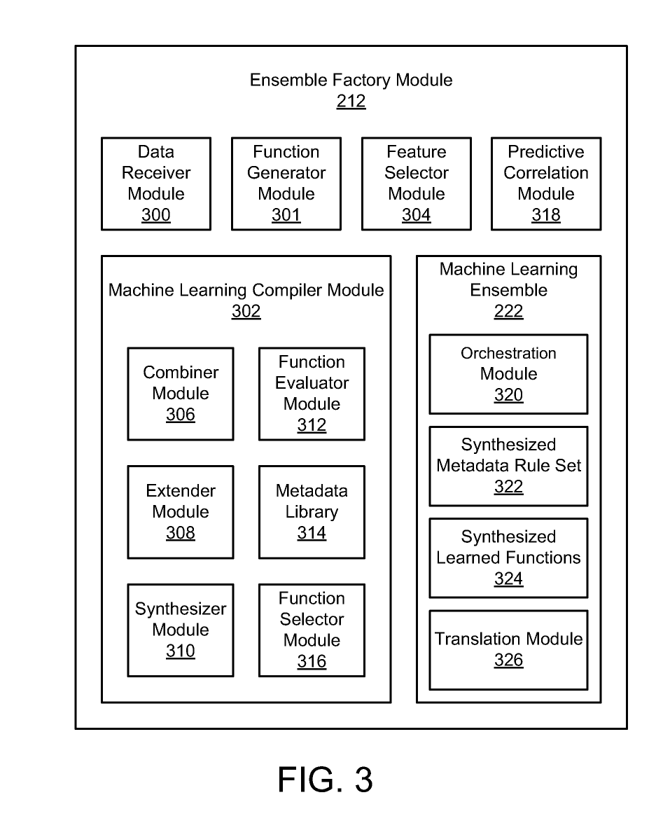

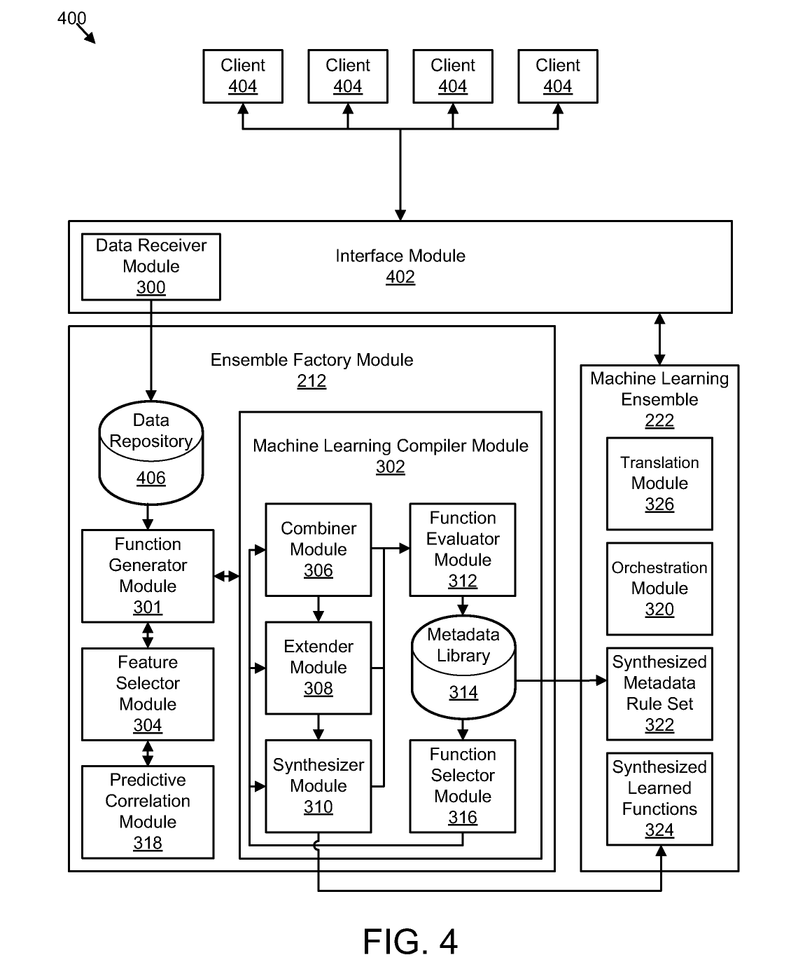

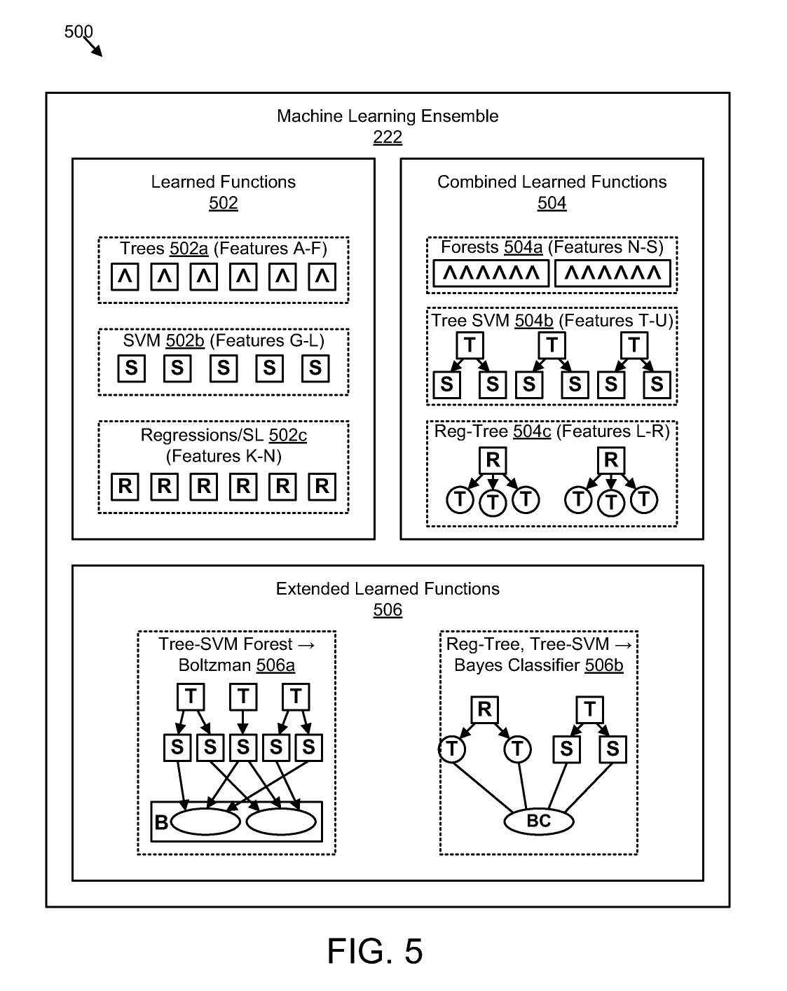

In order to determine a configuration or adjustment for one or more rules, settings, and/or thresholds of the systems management system 108, the machine learning module 102 may process systems management data, incident management data, or the like using machine learning, based on user information such as a label for a system state, an identified business activity, or the like. In other embodiments, the machine learning module 102 may use machine learning to determine a destination for an incident management alert, to provide a capacity projection or recommendation for a computing system 104 or other computing resource, to predict an incident for a computing system 104 or other computing resource, or to provide other management functions for the system 100. One example of machine learning that the machine learning module 102 may use to determine a rule, setting, threshold, or the like for the systems management system 108 is a machine learning ensemble as described in greater detail below with regard to FIG. 2B, FIG. 3, FIG. 4, and FIG. 5.

Instead of using default rules or determining rules blindly, without user input, in certain embodiments, the machine learning module 102 informs the creation, adjustment, and/or modification of rules based on user information, such as a label for a state, identification of a business activity, or the like. Once the machine learning module 102 has received user information, in one embodiment, the machine learning module 102 may configure, reconfigure, or otherwise modify the systems management system 108 in an automated manner, with little or no further input from a user 110 or the like. For example, the machine learning module 102 may add a rule, remove a rule, modify an existing rule, set a threshold, or the like without first receiving approval or authorization for each modification from a user 110. In this manner, the machine learning module 102, in certain embodiments, may optimize the systems management system 108 according to preferences of a user 110, with minimal input from the user 110, to provide more accurate or efficient rules, thresholds, or other settings, so that the systems management system 108 is more likely to be useful and accurate over time with minimal manual effort.

In embodiments where the systems management system 108 comprises and/or cooperates with an incident management system, the machine learning module 102 may use machine learning to route incident alerts to optimum destinations, such as a user 110, email account, telephone number, or other destination where the incident or other problem is most likely to be resolved. An incident management system, in certain embodiments, may be substantially similar to the systems management system 108 described above or may cooperate with a systems management system 108.

An incident management system, as used herein, manages alerts for and/or resolutions of incidents or other problems for one or more computing systems 104 or other computing resources. For example, an incident management system may receive incident reports from the systems management system 108, from a user 110, or the like and the incident management system may send an alert to a user 110 (e.g., an administrator, a technician, a customer service representative, or the like) assigning the incident to the user 110 receiving the alert. An incident management system, in one embodiment, may comprise a help desk or similar tool. Examples of incident management systems, in various embodiments, may include JIRA® from Atlassian Software Systems of Sydney, Australia; Advanced Help Desk from Pulse Solutions of New York, New York; Remedy® Action Request System® from BMC Software, Inc. of Houston, Tex.; or the like.

In certain embodiments, an incident management system may maintain incident management data, such as a history of incident management alerts, a history of incident management destinations, a history of incident outcomes, or other historical logged data. For example, the incident management system may monitor or track where an incident alert was sent, whether an incident was resolved, how long it took to resolve an incident, or the like. Instead of simply sending incident management alerts to a default user 110, in one embodiment, the machine learning module 102 cooperates with an incident management system to route incident management alerts using machine learning. As described above, in certain embodiments, the machine learning module 102 may modify a configuration of the systems management system 108 so that settings, rules, and/or thresholds of the systems management system 108 are more accurate, leading to more useful alerts, detection of incidents, or the like. In a further embodiment, the machine learning module 102 may reduce a mean time to repair or resolve a detected incident by using pattern recognition or other machine learning to route an incident management alert to a user 110 who is most likely to quickly and efficiently resolve the detected incident.

In one embodiment, the machine learning module 102 may monitor systems management data, incident management data, user information, or the like over time, modifying a configuration of the systems management system 108 substantially continuously. In other embodiments, the machine learning module 102 may configure the systems management system 108 at a discrete time, as a tune-up or diagnostic service, such as at an installation time of the systems management system 108, at periodic intervals, in response to a configuration request from a user 108, in response to an alert from the systems management system 108, or at another discrete time. For example, a vendor may provide the machine learning module 102 as a discrete service to a user 110 for periodically configuring or optimizing the systems management system 108, as an initial auto-configuration service for the systems management system 108, or the like.

FIG. 2A depicts one embodiment of a machine learning module 102. The machine learning module 102 of FIG. 2A, in certain embodiments, may be substantially similar to the machine learning module 102 described above with regard to FIG. 1. In the depicted embodiment, the machine learning module 102 includes an input module 202, a learned function module 204, and a result module 206.

In one embodiment, the input module 202 is configured to receive data as machine learning input for the learned function module 204 or the like. The input module 202, in one embodiment, may receive user information as a machine learning input as described below with regard to the user information module 214 of FIG. 2B. For example, the input module 202 may receive user input labeling or otherwise identifying a state of one or more computing systems 104 or other computing resources, user input identifying a business activity, or the like. The input module 202 may provide a user interface (e.g., a graphical user interface or GUI, a command-line interface or CLI, a configuration file, or the like) to a user 110 which the user 110 may use to provide user information. In one embodiment, the input module 202 may provide a user interface to a user 110 in response to or in association with an alert from the systems management system 108, allowing the user 110 to indicate whether the alert is accurate and/or desired, or to otherwise label or identify a state of one or more computing resources associated with the alert.

In certain embodiments, the input module 202 may collect or otherwise receive user sentiment data, indicating general sentiment or satisfaction of one or more users 110 with a state of one or more computing systems 104 or other computing resources, and/or with a business activity or service they provide. For example, user sentiment data may include a number or rate of calls in a call center, a number of incident reports submitted by users 110, a sentiment indicator received from a user 110 over a user interface (e.g., a user survey, a user complaint, a user interaction with a dedicated sentiment button), or the like. In certain embodiments, the input module 202 may monitor or otherwise receive Internet data indicating user sentiment, such as social network posts, blog posts, email messages, customer service chat messages, or the like. The machine learning module 102, in certain embodiments, may input user sentiment data from the input module 202 as an input for the learned function module 204, labeling a state of one or more computing systems 104 or other computing resources, or the like.

The input module 202, in a further embodiment, may receive systems management data as a machine learning input as described below with regard to the systems management data module 216 of FIG. 2B. In another embodiment, the input module 202 may receive incident management data as a machine learning input as described below with regard to the incident management data module 218 of FIG. 2B. The input module 202, in certain embodiments, may receive systems management data for one or more computing resources, as described below with regard to the system component module 220 of FIG. 2B, for use in determining capacity projections or recommendations or the like.

In one embodiment, the input module 202 may receive certain data directly from a systems management system 108, an incident management system, or another entity, that the entity has collected or gathered. For example, the input module 202 may access an API, a function call, a shared library, a hardware bus or other command interface, a shared data repository, or the like to request and receive systems management data, incident management data, or other data. In a further embodiment, the input module 202 may provide a user interface to receive data from a user 110, as described above. The input module 202, in another embodiment, may gather or collect data itself, from the one or more computing systems 104 or other computing resources, from a third party data repository over the data network 106, from one or more sensors, or the like.

In one embodiment, the learned function module 204 is configured to recognize and/or predict patterns, incidents, events, or the like in data from the input module 202 using machine learning. For example, the learned function module 204 may recognize a pattern in systems management data, recognize an incident in systems management data, predict an incident based on recognized patterns, estimate an effect of a capacity adjustment, determine a capacity projection, or the like as described in greater detail below with regard to the result module 206. The learned function module 204 may be configured to accept systems management data, incident management data, user information, user classifications, or other data from the input module 202 as machine learning inputs and to produce a result in cooperation with the result module 206.

In certain embodiments, the learned function module 204 may include one or more machine learning ensembles. Machine learning ensembles are described in greater detail below with regard to FIG. 2B, FIG. 3, FIG. 4, and FIG. 5. The machine learning that the learned function module 204 uses, whether as part of one or more machine learning ensembles or as independent learned functions, in various embodiments, may include decision trees; decision forests; kernel classifiers and regression machines with a plurality of reproducing kernels; non-kernel regression and classification machines such as logistic, classification and regression trees (CART), multi-layer neural nets with various topologies; Bayesian-type classifiers such as Naïve Bayes and Boltzmann machines; logistic regression; multinomial logistic regression; probit regression; auto regression (AR); moving average (MA); ARMA; AR conditional heteroskedasticity (ARCH); generalized ARCH (GARCH); vector AR (VAR); survival or duration analysis; multivariate adaptive regression splines (MARS); radial basis functions; support vector machines; k-nearest neighbors; geospatial predictive modeling; and/or other classes of machine learning.

A learned function (or machine learning ensemble) of the learned function module 204 may accept instance of one or more features as input, and provide a prediction, a classification, a confidence metric, an inferred function, a regression function, an answer, a subset of the instances, a subset of the one or more features, or the like as an output or result. In certain embodiments, a learned function or machine learning ensemble of the learned function module 204 may not be configured to output a desired result, such as a rule, a threshold, a setting, a recommendation, a configuration adjustment, or the like directly, and a translation module 326, as described below with regard to FIG. 3, may translate the output of a learned function or machine learning ensemble into a rule, a threshold, a setting, a recommendation, a configuration adjustment, or the like.

Each machine learning input from the input module 202, in certain embodiments, may comprise a feature with multiple instances over time. For example, the input module 202, either in cooperation with the systems management system 108 or independently, may monitor systems management data for one or more computing systems 104 or other computing resources as described above, and each statistic, metric, measurement, status, or the like that the input module 202 receives (e.g., CPU usage, network throughput, volatile memory usage, a storage device error rate, or the like) may comprise a different feature. As the input module 202 monitors the systems management data over time, the learned function module 204 may receive and process unique instances periodically, as time slices or snapshots in time of the state of the system 100 or of one or more individual computing systems 104 or other computing resources, and may determine a result for each periodic set of instances, e.g. for each input time slice or snapshot.

By using machine learning, such as a machine learning ensemble or set of machine learning ensembles, in one embodiment, the learned function module 204 may recognize complex patterns in systems management data, incident management data, or the like, involving multiple computing resources. The learned function module 204 may use the complex recognized patterns, and feedback from a user 110 labeling or identifying a state of one or more computing resources, to intelligently determine rules, settings, thresholds, or policies for the systems management system 108 which also be complex, involving multiple computing resources. For example, while a default rule for the systems management system 108 may rely on a single threshold for a single computing resource (e.g., alert when CPU usage is above X percent), the learned function module 204, using machine learning, may create a complex rule including thresholds or ranges for multiple computing resources, that is tuned based on a label for a state from a user 110, a business activity identified by a user 110, or the like (e.g., alert when CPU usage is above X percent while thread Y is executing and nonvolatile memory usage is above Z and the weather in the geographic region is above N degrees and a user sentiment indicator is negative).

The patterns and associated modifications determined by the learned function module 204, in certain embodiments, may be unexpected and difficult or impossible for a user 110 to detect on their own for manually configuring the systems management system 108, but may provide much more accurate and useful results or alerts than default rules. The learned function module 204 may cooperate with the ensemble factory module 212 to create machine learning ensembles 222 in an automated manner that are customized for particular systems management data, particular systems management rules, or the like, as described below.

In one embodiment, the result module 206 is configured to perform an action in response to a determination by the learned function module 204. The result module 206, in various embodiments, may modify a configuration of a systems management system 108, determine a destination for an incident management alert, decompose a business activity or set of user classifications into system management system rules, predict an incident, estimate an effect of a capacity adjustment, determine a capacity projection, or perform another action based on an identified state, a recognized pattern, a predicted incident, or the like from the learned function module 204. The result module 206 may be integrated with the learned function module 204, in communication with the learned function module 204, or may otherwise cooperate with the learned function module 204. The result module 206 is described in greater detail below with regard to FIG. 2B.

FIG. 2B depicts another embodiment of a machine learning module 102. In certain embodiments, the machine learning module 102 of FIG. 2B may be substantially similar to the machine learning module 102 described above with regard to FIG. 1 and/or FIG. 2A. In the depicted embodiment, the machine learning module 102 includes the input module 202, the learned function module 204, and the result module 206 and further includes a modification limit module 210 and an ensemble factory module 212. The input module 202, in the depicted embodiment, includes a user information module 214, a systems management data module 216, an incident management data module 218, and a system component module 220. The learned function module 204, in the depicted embodiment, includes one or more machine learning ensembles 222a-c. The result module 206, in the depicted embodiment, includes a systems management module 224, an incident management module 226, an incident prediction module 228, and a capacity planning module 230.

The input module 202, in certain embodiments, may include a user information module 214 to receive input from a user 110. In one embodiment, the user information module 214 may receive user information identifying or labeling a state of one or more computing systems 104 or other computing resources. For example, in response to a systems management alert from the systems management system 108, a user 110 may indicate to the user information module 214 whether the current system state is good or bad, positive or negative, or the like; whether the systems management alert accurately identifies the state of the one or more computing systems 104 or other computing resources; whether the systems management alert was desired; or otherwise identify or label a state of one or more computing systems 104 or other computing resources in response to the systems management alert. The user information module 214, in one embodiment, may receive user information dynamically during runtime of the systems management system 108, so that the learned function module 204 may make determinations based on the user information.

In another embodiment, the user information module 214 may receive user input identifying a business action, a set of user classifications for a performance metric associated with a business action, or the like. As described above, a business action may comprise a transaction or other event executed or performed by one or more computing resources such as a server transaction (e.g., for a web or application server), a database transaction, execution of predefined computer executable program code, a function call, or the like, that may be triggered by or visible to a user 110.

The learned function module 204 may use machine learning to monitor performance of an identified business action, in certain embodiments, as a tool for determining associations or dependencies between the business action and individual computing resources. For example, the learned function module 204 may determine that a business activity of “emailing” may use specific computing resources, which the input module 202 monitors such as an operating system, an application server, a CPU, a memory, or the like.

A user classification, in certain embodiments, may label one or more possible values of a performance metric associated with a business activity. For example, a set of user classifications may label or rank ranges of values of a performance metric by priority or desirability, descriptive labels (e.g., “worst,” “bad,” “good,” “better,” “best”), using stars (e.g., one star, two stars, three stars), an ordered list, and/or another label. The user information module 214, in one embodiment, may receive identification of a business activity, a set of user classifications for a performance metric associated with a business activity, or the like during a configuration process, setup process, workshop, or the like. The input module 202, using the system management data module 216 and/or the system component module 220, may monitor a business activity or otherwise receive values for a performance metric during runtime, so that the learned function module 204 may make determinations based on an identified business activity, values of the performance metric, a set of user classifications for the performance metric, or the like.

A business activity may comprise a high level event or transaction on one or more computing systems 104 that touches or involves a plurality of computing resources, system components, or the like so that performance of the business activity may comprise a measure or indication of a state of the computing resources. For example, a performance metric may comprise an amount of time to complete a business activity or other transaction (e.g., submitting or processing an order on a website, executing a script, running a query, or the like), a volume of transactions associated with a business activity (e.g., a size of transactions, an amount of transactions, a rate of transactions, or the like). In certain embodiments, a business activity may involve or be visible to a user 110, so that performance of the business activity is more likely to be noticeable to or otherwise relevant to the user 110.

In certain embodiments, the input module 202 uses a systems management data module 216 to receive systems management data. The systems management data module 216 may receive systems management data from a systems management system 108, may gather systems management data itself, or the like. Systems management data, as used herein, comprises data generated by and/or associated with a computing system 104 or other computing resources, an application executing on a computing system 104, an environment of a computing system 104, a user 110 of a computing system 104, a data network 106, a hardware device in communication with a computing system 104, a component of a computing system 104, a computing resource, or the like. For example, systems management data may include application log data or log files, a monitored hardware statistic, a processor usage metric, a volatile memory usage metric, a storage device metric, a business event or object, an identifier of an executing thread, a network event, a network metric, a transaction duration, a user sentiment indicator, a weather status for a geographic area of the one or more computing systems 104 or other computing resources, or the like.

The input module 202, in certain embodiments, may use the incident management data module 218 to receive incident management data. The incident management data module 218 may receive incident management data directly from an incident management system, may gather incident management data itself, or the like. As used herein, incident management data comprises data generated by or associated with detection and/or resolution of an incident for a computing system 104 or other computing resource, an application executing on a computing system 104, a data network 106, a hardware device in communication with a computing system 104, a component of a computing system 104, or the like. For example, incident management data may include a history of incident management alert destinations (e.g., a system administrator, technician, or other user 110 that received an incident management alert), incident outcomes (e.g., whether an incident was successfully resolved, how long it took to resolve an incident), or the like. The incident management data module 218 may dynamically monitor incident management data overtime, so that as patterns in the incident management data change, the machine learning module 102 may dynamically change routings of incident management alerts to different destinations or users 110 for resolution.

In certain embodiments, the input module 202 may use the system component module 220 to receive systems management data for one or more computing resources. The system component module 220 may be integrated with, cooperate with, or otherwise be in communication with the systems management data module 216. The system component module 220, in one embodiment, receives or processes systems management data for one or more computing resources, one or more types of computing resources, or the like, as input for the learned function module 204, so that the result module 206, in cooperation with the learned function module 204 or the like, may estimate an effect of adjusting a capacity of one or more computing resources. For example, the system component module 220 may receive systems management data for volatile memory, a nonvolatile storage device, a processor/CPU, a peer computing device, a network interface, or another computing resource, so that the capacity planning module 230 described below may provide an estimate of the effect of a capacity adjustment to the computing resource (e.g., adding additional computing resources, removing computing resources, or the like).

The result module 206, in certain embodiments, uses the systems management module 224 to modify a configuration of the systems management system 108 based on a determination from the learned function module 204 (e.g. a recognized pattern, a predicted incident, or the like) and/or data from the input module 202 (e.g. an identified state, an identified business activity or set of user classifications, incident management data, systems management data, or the like). For example, the systems management module 224, in cooperation with the learned function module 204 or the like, may modify the configuration of the systems management system 108 by adding a rule, modifying an existing rule, setting a threshold, intercepting an alert from the systems management system 108 (e.g., blocking the alert from a user 110, modifying the alert and forwarding it to a user 110, or the like).

In embodiments where the machine learning module 102 has direct access to rules, settings, threshold, and/or policies of the systems management system 108, the systems management module 224 may modify the rules, settings, thresholds, and/or policies themselves. In other embodiments, the machine learning module 102 may act as an intermediary between the systems management system 108 and a user 110, intercepting and/or filtering alerts based on user input and patterns the learned function module 204 recognizes in systems management data, or the like. The machine learning module 102, in certain embodiments, may be substantially transparent to a user 110, such that it appears as if the user 110 is interacting directly with the systems management system 108 or the like.

In certain embodiments, the result module 206 uses the incident management module 226 to modify a configuration of an incident management system based on a determination from the learned function module 204. For example, the incident management module 226, in cooperation with the learned function module 204 or the like, may determine a destination (e.g., a system administrator, technician, or other user 110) for an incident management alert based on a pattern identified in historical incident management data or the like. The result module 206 may cooperate with the incident management system to route incident management alerts and track or monitor resolutions of the detected incidents to generate new incident management data, allowing the learned function module 204 to recognize new patterns, increase accuracy of incident management alert routing, and the like over time.

The result module 206, in certain embodiments, uses the incident prediction module 228, in cooperation with the learned function module 204, to predict an incident for one or more computing systems 104 or other computing resources. For example, the incident prediction module 228 may predict an incident based on an identified state, a recognized pattern, incident management data, systems management data, or the like. For example, the learned function module 204 may recognize, in systems management data, a precursor state or pattern for a state which a user 110 has labeled or identified as an incident, or the like. The incident management module 226, in one embodiment, may determine a destination for an incident management alert in response to a predicted incident from the incident prediction module 228. In a further embodiment, the systems management module 224 may modify a configuration of the systems management system 108 in response to a predicted incident from the incident prediction module 228.

In certain embodiments, the result module 206 uses the capacity planning module 230 to estimate an effect of adjusting a capacity of one or more computing resources, in response to the learned function module 204 making a determination based on systems management data for the one or more computing resources of the like. The capacity planning module 230, in one embodiment, determines an estimated effect as one or more estimated system performance metrics or the like. For example, a user 110 may identify a business activity, the learned function module 204 may associate the business activity with one or more computing resources, and the capacity planning module 230 may predict, estimate, or otherwise provide a capacity projection for the one or more computing resources based on a pattern of resource consumption associated with the identified business activity. A capacity projection, in one embodiment, may comprise an estimate of an effect of adjusting a capacity of a computing resource (e.g., if a capacity is adjusted by N an associated performance metric will change by X) and/or a capacity adjustment recommendation (e.g., increase the capacity of the computing resource by Y). In another embodiment, a capacity projection may comprise a prediction of an incident associated with a capacity of at least one computing resource (e.g., a capacity of a computing resource will be insufficient in X amount of time, a capacity of a first computing resource will cause an incident in a second computing resource in Y amount of time, or the like).

In one embodiment, to ensure that the machine learning module 102 is not overly burdensome on the systems management system 108 or the like, the machine learning module 102 includes the modification limit module. The modification limit module 210, in certain embodiments, is configured to limit an amount of modifications that the machine learning module 102, using the result module 206 or the like, may make to the configuration of the systems management system 108. For example, the modification limit module 210 may ensure that the amount of modifications to the systems management system 108 satisfies a performance threshold or the like. In various embodiments, the modification limit module 210 may limit a number of rules that the result module 206 may add to the systems management system 108, may limit a number of adjustments that the result module 206 may make to existing rules in the systems management system 108, may limit a total number of rules used by the systems management system 108, may limit a frequency with which the result module 206 may modify a configuration of the systems management system 108, or the like.

In one embodiment, the ensemble factory module 212 is configured to form one or more machine learning ensembles 222a-c for the learned function module 204. In certain embodiments, the learned function module 204 may include a plurality of machine learning ensembles 222a-c, for different rules, settings, and/or thresholds of the systems management system 108, for incident prediction, for incident management, for capacity planning, or the like.

The ensemble factory module 212, in certain embodiments, generates machine learning ensembles 222a-c with little or no input from a Data Scientist or other expert, by generating a large number of learned functions from multiple different classes, evaluating, combining, and/or extending the learned functions, synthesizing selected learned functions, and organizing the synthesized learned functions into a machine learning ensemble 222. The ensemble factory module 212, in one embodiment, services analysis requests with input from the input module 202 using the generated one or more machine learning ensembles 222a-c to provide results; recognize patterns; determine a rule, threshold, and/or setting for the systems management system 108; determine a destination for an incident management alert; determine a capacity projection; or the like for the result module 206. While the learned function module 204, in the depicted embodiment, includes three machine learning ensembles 222a-c, in other embodiments, the learned function module 204 may include one or more single learned functions not organized into a machine learning ensemble 222; a single machine learning ensemble 222; tens, hundreds, or thousands of machine learning ensembles 222; or the like.

By generating a large number of learned functions, without regard to the effectiveness of the generated learned functions, without prior knowledge of the generated learned functions suitability, or the like, and evaluating the generated learned functions, in certain embodiments, the ensemble factory module 212 may provide machine learning ensembles 222a-c that are customized and finely tuned for a particular machine learning application, without excessive intervention or fine-tuning. The ensemble factory module 212, in a further embodiment, may generate and evaluate a large number of learned functions using parallel computing on multiple processors, such as a massively parallel processing (MPP) system or the like. Machine learning ensembles 222 are described in greater detail below with regard to FIG. 3, FIG. 4, and FIG. 5.

FIG. 3 depicts another embodiment of an ensemble factory module 212. The ensemble factory module 212 of FIG. 3, in certain embodiments, may be substantially similar to the ensemble factory module 212 described above with regard to FIG. 2B. In the depicted embodiment, the ensemble factory module 212 includes a data receiver module 300, a function generator module 301, a machine learning compiler module 302, a feature selector module 304 a predictive correlation module 318, and a machine learning ensemble 222. The machine learning compiler module 302, in the depicted embodiment, includes a combiner module 306, an extender module 308, a synthesizer module 310, a function evaluator module 312, a metadata library 314, and a function selector module 316. The machine learning ensemble 222, in the depicted embodiment, includes an orchestration module 320, a synthesized metadata rule set 322, synthesized learned functions 324, and a translation module 326.

The data receiver module 300, in certain embodiments, is configured to receive input data, such as training data, test data, workload data, systems management data, incident management data, user input data, or the like, from the learned function module 204, the input module 202, or another client, either directly or indirectly. The data receiver module 300, in various embodiments, may receive data over a local channel 108 such as an API, a shared library, a hardware command interface, or the like; over a data network 106 such as wired or wireless LAN, WAN, the Internet, a serial connection, a parallel connection, or the like. In certain embodiments, the data receiver module 300 may receive data indirectly from the learned function module 204 or another client through an intermediate module that may pre-process, reformat, or otherwise prepare the data for the ensemble factory module 212. The data receiver module 300 may support structured data, unstructured data, semi-structured data, or the like.

One type of data that the data receiver module 300 may receive, as part of a new ensemble request or the like, is initialization data. The ensemble factory module 212, in certain embodiments, may use initialization data to train and test learned functions from which the ensemble factory module 212 may build a machine learning ensemble 222. Initialization data may comprise historical data, statistics, Big Data, customer data, marketing data, computer system logs, computer application logs, data networking logs, systems management data, incident management data, user input data, or other data that the learned function module 204, the input module 202, or another client provides to the data receiver module 300 with which to build, initialize, train, and/or test a machine learning ensemble 222.

Another type of data that the data receiver module 300 may receive, as part of an analysis request or the like, is workload data. As described above, the input module 202, either in cooperation with the systems management system 108 or independently, may monitor systems management data, incident management data, user input, or the like for one or more computing systems 104 or other computing resources, and each statistic, metric, measurement, status, label, identification, business activity, or the like that the input module 202 receives may comprise a different feature. The input module 202 and/or the learned function module 204, in certain embodiments, may provide instances of monitored data (e.g., systems management data, incident management data, user input) to the data receiver module 300 as workload data, which may comprise a time slice or snapshot of the state of the system 100 or of one or more individual computing systems 104 or other computing resources as described above.

The ensemble factory module 212, in certain embodiments, may process workload data using a machine learning ensemble 222 to obtain a result, such as a prediction, a classification, a confidence metric, an answer, a recognized pattern, a rule, a threshold, a setting, a recommendation, or the like. Workload data for a specific machine learning ensemble 222, in one embodiment, has substantially the same format as the initialization data used to train and/or evaluate the machine learning ensemble 222. For example, initialization data and/or workload data may include one or more features. As used herein, a feature may comprise a column, category, data type, attribute, characteristic, label, or other grouping of data. For example, in embodiments where initialization data and/or workload data that is organized in a table format, a column of data may be a feature. Initialization data and/or workload data may include one or more instances of the associated features. In a table format, where columns of data are associated with features, a row of data is an instance.

As described below with regard to FIG. 4, in one embodiment, the data receiver module 300 may maintain client data, such as initialization data and/or workload data, in a data repository 406, where the function generator module 301, the machine learning compiler module 302, or the like may access the data. In certain embodiments, as described below, the function generator module 301 and/or the machine learning compiler module 302 may divide initialization data into subsets, using certain subsets of data as training data for generating and training learned functions and using certain subsets of data as test data for evaluating generated learned functions.

The function generator module 301, in certain embodiments, is configured to generate a plurality of learned functions based on training data from the data receiver module 300. A learned function, as used herein, comprises a computer readable code that accepts an input and provides a result. A learned function may comprise a compiled code, a script, text, a data structure, a file, a function, or the like. In certain embodiments, a learned function may accept instances of one or more features as input, and provide a result, such as a classification, a confidence metric, an inferred function, a regression function, an answer, a recognized pattern, a rule, a threshold, a setting, a recommendation, or the like. In another embodiment, certain learned functions may accept instances of one or more features as input, and provide a subset of the instances, a subset of the one or more features, or the like as an output. In a further embodiment, certain learned functions may receive the output or result of one or more other learned functions as input, such as a Bayes classifier, a Boltzmann machine, or the like.

The function generator module 301 may generate learned functions from multiple different machine learning classes, models, or algorithms. For example, the function generator module 301 may generate decision trees; decision forests; kernel classifiers and regression machines with a plurality of reproducing kernels; non-kernel regression and classification machines such as logistic, CART, multi-layer neural nets with various topologies; Bayesian-type classifiers such as Naïve Bayes and Boltzmann machines; logistic regression; multinomial logistic regression; probit regression; AR; MA; ARMA; ARCH; GARCH; VAR; survival or duration analysis; MARS; radial basis functions; support vector machines; k-nearest neighbors; geospatial predictive modeling; and/or other classes of learned functions.

In one embodiment, the function generator module 301 generates learned functions pseudo-randomly, without regard to the effectiveness of the generated learned functions, without prior knowledge regarding the suitability of the generated learned functions for the associated training data, or the like. For example, the function generator module 301 may generate a total number of learned functions that is large enough that at least a subset of the generated learned functions are statistically likely to be effective. As used herein, pseudo-randomly indicates that the function generator module 301 is configured to generate learned functions in an automated manner, without input or selection of learned functions, machine learning classes or models for the learned functions, or the like by a Data Scientist, expert, or other user.

The function generator module 301, in certain embodiments, generates as many learned functions as possible for a requested machine learning ensemble 222, given one or more parameters or limitations. The learned function module 204 or another client may provide a parameter or limitation for learned function generation as part of a new ensemble request or the like to an interface module 402 as described below with regard to FIG. 4, such as an amount of time; an allocation of system resources such as a number of processor nodes or cores, or an amount of volatile memory; a number of learned functions; runtime constraints on the requested ensemble such as an indicator of whether or not the requested ensemble should provide results in real-time; and/or another parameter or limitation from the learned function module 204 or another client.

The number of learned functions that the function generator module 301 may generate for building a machine learning ensemble 222 may also be limited by capabilities of the system 100, such as a number of available processors or processor cores, a current load on the system 100, a price of remote processing resources over the data network 106; or other hardware capabilities of the system 100 available to the function generator module 301. The function generator module 301 may balance the hardware capabilities of the system 100 with an amount of time available for generating learned functions and building a machine learning ensemble 222 to determine how many learned functions to generate for the machine learning ensemble 222.

In one embodiment, the function generator module 301 may generate at least 50 learned functions for a machine learning ensemble 222. In a further embodiment, the function generator module 301 may generate hundreds, thousands, or millions of learned functions, or more, for a machine learning ensemble 222. By generating an unusually large number of learned functions from different classes without regard to the suitability or effectiveness of the generated learned functions for training data, in certain embodiments, the function generator module 301 ensures that at least a subset of the generated learned functions, either individually or in combination, are useful, suitable, and/or effective for the training data without careful curation and fine tuning by a Data Scientist or other expert.

Similarly, by generating learned functions from different machine learning classes without regard to the effectiveness or the suitability of the different machine learning classes for training data, the function generator module 301, in certain embodiments, may generate learned functions that are useful, suitable, and/or effective for the training data due to the sheer amount of learned functions generated from the different machine learning classes. This brute force, trial-and-error approach to generating learned functions, in certain embodiments, eliminates or minimizes the role of a Data Scientist or other expert in generation of a machine learning ensemble 222.

The function generator module 301, in certain embodiments, divides initialization data from the data receiver module 300 into various subsets of training data, and may use different training data subsets, different combinations of multiple training data subsets, or the like to generate different learned functions. The function generator module 301 may divide the initialization data into training data subsets by feature, by instance, or both. For example, a training data subset may comprise a subset of features of initialization data, a subset of features of initialization data, a subset of both features and instances of initialization data, or the like. Varying the features and/or instances used to train different learned functions, in certain embodiments, may further increase the likelihood that at least a subset of the generated learned functions are useful, suitable, and/or effective. In a further embodiment, the function generator module 301 ensures that the available initialization data is not used in its entirety as training data for any one learned function, so that at least a portion of the initialization data is available for each learned function as test data, which is described in greater detail below with regard to the function evaluator module 312 of FIG. 3.

In one embodiment, the function generator module 301 may also generate additional learned functions in cooperation with the machine learning compiler module 302. The function generator module 301 may provide a learned function request interface, allowing the machine learning compiler module 302, the learned function module 204, another module, another client, or the like to send a learned function request to the function generator module 301 requesting that the function generator module 301 generate one or more additional learned functions. In one embodiment, a learned function request may include one or more attributes for the requested one or more learned functions. For example, a learned function request, in various embodiments, may include a machine learning class for a requested learned function, one or more features for a requested learned function, instances from initialization data to use as training data for a requested learned function, runtime constraints on a requested learned function, or the like. In another embodiment, a learned function request may identify initialization data, training data, or the like for one or more requested learned functions and the function generator module 301 may generate the one or more learned functions pseudo-randomly, as described above, based on the identified data.

The machine learning compiler module 302, in one embodiment, is configured to form a machine learning ensemble 222 using learned functions from the function generator module 301. As used herein, a machine learning ensemble 222 comprises an organized set of a plurality of learned functions. Providing a classification, a confidence metric, an inferred function, a regression function, an answer, a recognized pattern, a rule, a threshold, a setting, a recommendation, or another result using a machine learning ensemble 222, in certain embodiments, may be more accurate than using a single learned function.

The machine learning compiler module 302 is described in greater detail below with regard to FIG. 3. The machine learning compiler module 302, in certain embodiments, may combine and/or extend learned functions to form new learned functions, may request additional learned functions from the function generator module 301, or the like for inclusion in a machine learning ensemble 222. In one embodiment, the machine learning compiler module 302 evaluates learned functions from the function generator module 301 using test data to generate evaluation metadata. The machine learning compiler module 302, in a further embodiment, may evaluate combined learned functions, extended learned functions, combined-extended learned functions, additional learned functions, or the like using test data to generate evaluation metadata.

The machine learning compiler module 302, in certain embodiments, maintains evaluation metadata in a metadata library 314, as described below with regard to FIGS. 3 and 4. The machine learning compiler module 302 may select learned functions (e.g. learned functions from the function generator module 301, combined learned functions, extended learned functions, learned functions from different machine learning classes, and/or combined-extended learned functions) for inclusion in a machine learning ensemble 222 based on the evaluation metadata. In a further embodiment, the machine learning compiler module 302 may synthesize the selected learned functions into a final, synthesized function or function set for a machine learning ensemble 222 based on evaluation metadata. The machine learning compiler module 302, in another embodiment, may include synthesized evaluation metadata in a machine learning ensemble 222 for directing data through the machine learning ensemble 222 or the like.

In one embodiment, the feature selector module 304 determines which features of initialization data to use in the machine learning ensemble 222, and in the associated learned functions, and/or which features of the initialization data to exclude from the machine learning ensemble 222, and from the associated learned functions. As described above, initialization data, and the training data and testing data derived from the initialization data, may include one or more features. Learned functions and the machine learning ensembles 222 that they form are configured to receive and process instances of one or more features. Certain features may be more predictive than others, and the more features that the machine learning compiler module 302 processes and includes in the generated machine learning ensemble 222, the more processing overhead used by the machine learning compiler module 302, and the more complex the generated machine learning ensemble 222 becomes. Additionally, certain features may not contribute to the effectiveness or accuracy of the results from a machine learning ensemble 222, but may simply add noise to the results.

The feature selector module 304, in one embodiment, cooperates with the function generator module 301 and the machine learning compiler module 302 to evaluate the effectiveness of various features, based on evaluation metadata from the metadata library 314 described below. For example, the function generator module 301 may generate a plurality of learned functions for various combinations of features, and the machine learning compiler module 302 may evaluate the learned functions and generate evaluation metadata. Based on the evaluation metadata, the feature selector module 304 may select a subset of features that are most accurate or effective, and the machine learning compiler module 302 may use learned functions that utilize the selected features to build the machine learning ensemble 222. The feature selector module 304 may select features for use in the machine learning ensemble 222 based on evaluation metadata for learned functions from the function generator module 301, combined learned functions from the combiner module 306, extended learned functions from the extender module 308, combined extended functions, synthesized learned functions from the synthesizer module 310, or the like.

In a further embodiment, the feature selector module 304 may cooperate with the machine learning compiler module 302 to build a plurality of different machine learning ensembles 222 for the same initialization data or training data, each different machine learning ensemble 222 utilizing different features of the initialization data or training data. The machine learning compiler module 302 may evaluate each different machine learning ensemble 222, using the function evaluator module 312 described below, and the feature selector module 304 may select the machine learning ensemble 222 and the associated features which are most accurate or effective based on the evaluation metadata for the different machine learning ensembles 222. In certain embodiments, the machine learning compiler module 302 may generate tens, hundreds, thousands, millions, or more different machine learning ensembles 222 so that the feature selector module 304 may select an optimal set of features (e.g. the most accurate, most effective, or the like) with little or no input from a Data Scientist, expert, or other user in the selection process.

In one embodiment, the machine learning compiler module 302 may generate a machine learning ensemble 222 for each possible combination of features from which the feature selector module 304 may select. In a further embodiment, the machine learning compiler module 302 may begin generating machine learning ensembles 222 with a minimal number of features, and may iteratively increase the number of features used to generate machine learning ensembles 222 until an increase in effectiveness or usefulness of the results of the generated machine learning ensembles 222 fails to satisfy a feature effectiveness threshold. By increasing the number of features until the increases stop being effective, in certain embodiments, the machine learning compiler module 302 may determine a minimum effective set of features for use in a machine learning ensemble 222, so that generation and use of the machine learning ensemble 222 is both effective and efficient. The feature effectiveness threshold may be predetermined or hard coded, may be selected by the learned function module 204 or another client as part of a new ensemble request or the like, may be based on one or more parameters or limitations, or the like.

During the iterative process, in certain embodiments, once the feature selector module 304 determines that a feature is merely introducing noise, the machine learning compiler module 302 excludes the feature from future iterations, and from the machine learning ensemble 222. In one embodiment, the learned function module 204 or another client may identify one or more features as required for the machine learning ensemble 222, in a new ensemble request or the like. The feature selector module 304 may include the required features in the machine learning ensemble 222, and select one or more of the remaining optional features for inclusion in the machine learning ensemble 222 with the required features.

In a further embodiment, based on evaluation metadata from the metadata library 314, the feature selector module 304 determines which features from initialization data and/or training data are adding noise, are not predictive, are the least effective, or the like, and excludes the features from the machine learning ensemble 222. In other embodiments, the feature selector module 304 may determine which features enhance the quality of results, increase effectiveness, or the like, and selects the features for the machine learning ensemble 222.

In one embodiment, the feature selector module 304 causes the machine learning compiler module 302 to repeat generating, combining, extending, and/or evaluating learned functions while iterating through permutations of feature sets. At each iteration, the function evaluator module 312 may determine an overall effectiveness of the learned functions in aggregate for the current iteration's selected combination of features. Once the feature selector module 304 identifies a feature as noise introducing, the feature selector module may exclude the noisy feature and the machine learning compiler module 302 may generate a machine learning ensemble 222 without the excluded feature. In one embodiment, the predictive correlation module 318 determines one or more features, instances of features, or the like that correlate with higher confidence metrics (e.g. that are most effective in predicting results with high confidence). The predictive correlation module 318 may cooperate with, be integrated with, or otherwise work in concert with the feature selector module 304 to determine one or more features, instances of features, or the like that correlate with higher confidence metrics. For example, as the feature selector module 304 causes the machine learning compiler module 302 to generate and evaluate learned functions with different sets of features, the predictive correlation module 318 may determine which features and/or instances of features correlate with higher confidence metrics, are most effective, or the like based on metadata from the metadata library 314.

The predictive correlation module 318, in certain embodiments, is configured to harvest metadata regarding which features correlate to higher confidence metrics, to determine which feature was predictive of which outcome or result, or the like. In one embodiment, the predictive correlation module 318 determines the relationship of a feature's predictive qualities for a specific outcome or result based on each instance of a particular feature. In other embodiments, the predictive correlation module 318 may determine the relationship of a feature's predictive qualities based on a subset of instances of a particular feature. For example, the predictive correlation module 318 may discover a correlation between one or more features and the confidence metric of a predicted result by attempting different combinations of features and subsets of instances within an individual feature's dataset, and measuring an overall impact on predictive quality, accuracy, confidence, or the like. The predictive correlation module 318 may determine predictive features at various granularities, such as per feature, per subset of features, per instance, or the like.

In one embodiment, the predictive correlation module 318 determines one or more features with a greatest contribution to a predicted result or confidence metric as the machine learning compiler module 302 forms the machine learning ensemble 222, based on evaluation metadata from the metadata library 314, or the like. For example, the machine learning compiler module 302 may build one or more synthesized learned functions 324 that are configured to provide one or more features with a greatest contribution as part of a result. In another embodiment, the predictive correlation module 318 may determine one or more features with a greatest contribution to a predicted result or confidence metric dynamically at runtime as the machine learning ensemble 222 determines the predicted result or confidence metric. In such embodiments, the predictive correlation module 318 may be part of, integrated with, or in communication with the machine learning ensemble 222. The predictive correlation module 318 may cooperate with the machine learning ensemble 222, such that the machine learning ensemble 222 provides a listing of one or more features that provided a greatest contribution to a predicted result or confidence metric as part of a response to an analysis request.

In determining features that are predictive, or that have a greatest contribution to a predicted result or confidence metric, the predictive correlation module 318 may balance a frequency of the contribution of a feature and/or an impact of the contribution of the feature. For example, a certain feature or set of features may contribute to the predicted result or confidence metric frequently, for each instance or the like, but have a low impact. Another feature or set of features may contribute relatively infrequently, but has a very high impact on the predicted result or confidence metric (e.g. provides at or near 100% confidence or the like). While the predictive correlation module 318 is described herein as determining features that are predictive or that have a greatest contribution, in other embodiments, the predictive correlation module 318 may determine one or more specific instances of a feature that are predictive, have a greatest contribution to a predicted result or confidence metric, or the like.

In the depicted embodiment, the machine learning compiler module 302 includes a combiner module 306. The combiner module 306 combines learned functions, forming sets, strings, groups, trees, or clusters of combined learned functions. In certain embodiments, the combiner module 306 combines learned functions into a prescribed order, and different orders of learned functions may have different inputs, produce different results, or the like. The combiner module 306 may combine learned functions in different combinations. For example, the combiner module 306 may combine certain learned functions horizontally or in parallel, joined at the inputs and at the outputs or the like, and may combine certain learned functions vertically or in series, feeding the output of one learned function into the input of another learned function.

The combiner module 306 may determine which learned functions to combine, how to combine learned functions, or the like based on evaluation metadata for the learned functions from the metadata library 314, generated based on an evaluation of the learned functions using test data, as described below with regard to the function evaluator module 312. The combiner module 306 may request additional learned functions from the function generator module 301, for combining with other learned functions. For example, the combiner module 306 may request a new learned function with a particular input and/or output to combine with an existing learned function, or the like.

While the combining of learned functions may be informed by evaluation metadata for the learned functions, in certain embodiments, the combiner module 306 combines a large number of learned functions pseudo-randomly, forming a large number of combined functions. For example, the combiner module 306, in one embodiment, may determine each possible combination of generated learned functions, as many combinations of generated learned functions as possible given one or more limitations or constraints, a selected subset of combinations of generated learned functions, or the like, for evaluation by the function evaluator module 312. In certain embodiments, by generating a large number of combined learned functions, the combiner module 306 is statistically likely to form one or more combined learned functions that are useful and/or effective for the training data.

In the depicted embodiment, the machine learning compiler module 302 includes an extender module 308. The extender module 308, in certain embodiments, is configured to add one or more layers to a learned function. For example, the extender module 308 may extend a learned function or combined learned function by adding a probabilistic model layer, such as a Bayesian belief network layer, a Bayes classifier layer, a Boltzman layer, or the like.

Certain classes of learned functions, such as probabilistic models, may be configured to receive either instances of one or more features as input, or the output results of other learned functions, such as a classification and a confidence metric, or the like. The extender module 308 may use these types of learned functions to extend other learned functions. The extender module 308 may extend learned functions generated by the function generator module 301 directly, may extend combined learned functions from the combiner module 306, may extend other extended learned functions, may extend synthesized learned functions from the synthesizer module 310, or the like.

In one embodiment, the extender module 308 determines which learned functions to extend, how to extend learned functions, or the like based on evaluation metadata from the metadata library 314. The extender module 308, in certain embodiments, may request one or more additional learned functions from the function generator module 301 and/or one or more additional combined learned functions from the combiner module 306, for the extender module 308 to extend.

While the extending of learned functions may be informed by evaluation metadata for the learned functions, in certain embodiments, the extender module 308 generates a large number of extended learned functions pseudo-randomly. For example, the extender module 308, in one embodiment, may extend each possible learned function and/or combination of learned functions, may extend a selected subset of learned functions, may extend as many learned functions as possible given one or more limitations or constraints, or the like, for evaluation by the function evaluator module 312. In certain embodiments, by generating a large number of extended learned functions, the extender module 308 is statistically likely to form one or more extended learned functions and/or combined extended learned functions that are useful and/or effective for the training data.

In the depicted embodiment, the machine learning compiler module 302 includes a synthesizer module 310. The synthesizer module 310, in certain embodiments, is configured to organize a subset of learned functions into the machine learning ensemble 222, as synthesized learned functions 324. In a further embodiment, the synthesizer module 310 includes evaluation metadata from the metadata library 314 of the function evaluator module 312 in the machine learning ensemble 222 as a synthesized metadata rule set 322, so that the machine learning ensemble 222 includes synthesized learned functions 324 and evaluation metadata, the synthesized metadata rule set 322, for the synthesized learned functions 324.

The learned functions that the synthesizer module 310 synthesizes or organizes into the synthesized learned functions 324 of the machine learning ensemble 222, may include learned functions directly from the function generator module 301, combined learned functions from the combiner module 306, extended learned functions from the extender module 308, combined extended learned functions, or the like. As described below, in one embodiment, the function selector module 316 selects the learned functions for the synthesizer module 310 to include in the machine learning ensemble 222. In certain embodiments, the synthesizer module 310 organizes learned functions by preparing the learned functions and the associated evaluation metadata for processing workload data to reach a result. For example, as described below, the synthesizer module 310 may organize and/or synthesize the synthesized learned functions 324 and the synthesized metadata rule set 322 for the orchestration module 320 to use to direct workload data through the synthesized learned functions 324 to produce a result.

In one embodiment, the function evaluator module 312 evaluates the synthesized learned functions 324 that the synthesizer module 310 organizes, and the synthesizer module 310 synthesizes and/or organizes the synthesized metadata rule set 322 based on evaluation metadata that the function evaluation module 312 generates during the evaluation of the synthesized learned functions 324, from the metadata library 314 or the like.

In the depicted embodiment, the machine learning compiler module 302 includes a function evaluator module 312. The function evaluator module 312 is configured to evaluate learned functions using test data, or the like. The function evaluator module 312 may evaluate learned functions generated by the function generator module 301, learned functions combined by the combiner module 306 described above, learned functions extended by the extender module 308 described above, combined extended learned functions, synthesized learned functions 324 organized into the machine learning ensemble 222 by the synthesizer module 310 described above, or the like.

Test data for a learned function, in certain embodiments, comprises a different subset of the initialization data for the learned function than the function generator module 301 used as training data. The function evaluator module 312, in one embodiment, evaluates a learned function by inputting the test data into the learned function to produce a result, such as a classification, a confidence metric, an inferred function, a regression function, an answer, a recognized pattern, a rule, a threshold, a setting, a recommendation, or another result.

Test data, in certain embodiments, comprises a subset of initialization data, with a feature associated with the requested result removed, so that the function evaluator module 312 may compare the result from the learned function to the instances of the removed feature to determine the accuracy and/or effectiveness of the learned function for each test instance. For example, if the learned function module 204 or another client has requested a machine learning ensemble 222 to predict whether a customer will be a repeat customer, and provided historical customer information as initialization data, the function evaluator module 312 may input a test data set comprising one or more features of the initialization data other than whether the customer was a repeat customer into the learned function, and compare the resulting predictions to the initialization data to determine the accuracy and/or effectiveness of the learned function.

The function evaluator module 312, in one embodiment, is configured to maintain evaluation metadata for an evaluated learned function in the metadata library 314. The evaluation metadata, in certain embodiments, comprises log data generated by the function generator module 301 while generating learned functions, the function evaluator module 312 while evaluating learned functions, or the like.

In one embodiment, the evaluation metadata includes indicators of one or more training data sets that the function generator module 301 used to generate a learned function. The evaluation metadata, in another embodiment, includes indicators of one or more test data sets that the function evaluator module 312 used to evaluate a learned function. In a further embodiment, the evaluation metadata includes indicators of one or more decisions made by and/or branches taken by a learned function during an evaluation by the function evaluator module 312. The evaluation metadata, in another embodiment, includes the results determined by a learned function during an evaluation by the function evaluator module 312. In one embodiment, the evaluation metadata may include evaluation metrics, learning metrics, effectiveness metrics, convergence metrics, or the like for a learned function based on an evaluation of the learned function. An evaluation metric, learning metrics, effectiveness metric, convergence metric, or the like may be based on a comparison of the results from a learned function to actual values from initialization data, and may be represented by a correctness indicator for each evaluated instance, a percentage, a ratio, or the like. Different classes of learned functions, in certain embodiments, may have different types of evaluation metadata.

The metadata library 314, in one embodiment, provides evaluation metadata for learned functions to the feature selector module 304, the predictive correlation module 318, the combiner module 306, the extender module 308, and/or the synthesizer module 310. The metadata library 314 may provide an API, a shared library, one or more function calls, or the like providing access to evaluation metadata. The metadata library 314, in various embodiments, may store or maintain evaluation metadata in a database format, as one or more flat files, as one or more lookup tables, as a sequential log or log file, or as one or more other data structures. In one embodiment, the metadata library 314 may index evaluation metadata by learned function, by feature, by instance, by training data, by test data, by effectiveness, and/or by another category or attribute and may provide query access to the indexed evaluation metadata. The function evaluator module 312 may update the metadata library 314 in response to each evaluation of a learned function, adding evaluation metadata to the metadata library 314 or the like.

The function selector module 316, in certain embodiments, may use evaluation metadata from the metadata library 314 to select learned functions for the combiner module 306 to combine, for the extender module 308 to extend, for the synthesizer module 310 to include in the machine learning ensemble 222, or the like. For example, in one embodiment, the function selector module 316 may select learned functions based on evaluation metrics, learning metrics, effectiveness metrics, convergence metrics, or the like. In another embodiment, the function selector module 316 may select learned functions for the combiner module 306 to combine and/or for the extender module 308 to extend based on features of training data used to generate the learned functions, or the like.

The machine learning ensemble 222, in certain embodiments, provides predictive results for an analysis request by processing workload data of the analysis request using a plurality of learned functions (e.g., the synthesized learned functions 324). As described above, results from the machine learning ensemble 222, in various embodiments, may include a classification, a confidence metric, an inferred function, a regression function, an answer, a recognized pattern, a rule, a threshold, a setting, a recommendation, and/or another result. For example, in one embodiment, the machine learning ensemble 222 provides a classification and a confidence metric or another result for each instance of workload data input into the machine learning ensemble 222, or the like. Workload data, in certain embodiments, may be substantially similar to test data, but the missing feature from the initialization data is not known, and is to be solved for by the machine learning ensemble 222. A classification, in certain embodiments, comprises a value for a missing feature in an instance of workload data, such as a prediction, an answer, or the like. For example, if the missing feature represents a question, the classification may represent a predicted answer, and the associated confidence metric may be an estimated strength or accuracy of the predicted answer. A classification, in certain embodiments, may comprise a binary value (e.g., yes or no), a rating on a scale (e.g., 4 on a scale of 1 to 5), or another data type for a feature. A confidence metric, in certain embodiments, may comprise a percentage, a ratio, a rating on a scale, or another indicator of accuracy, effectiveness, and/or confidence.

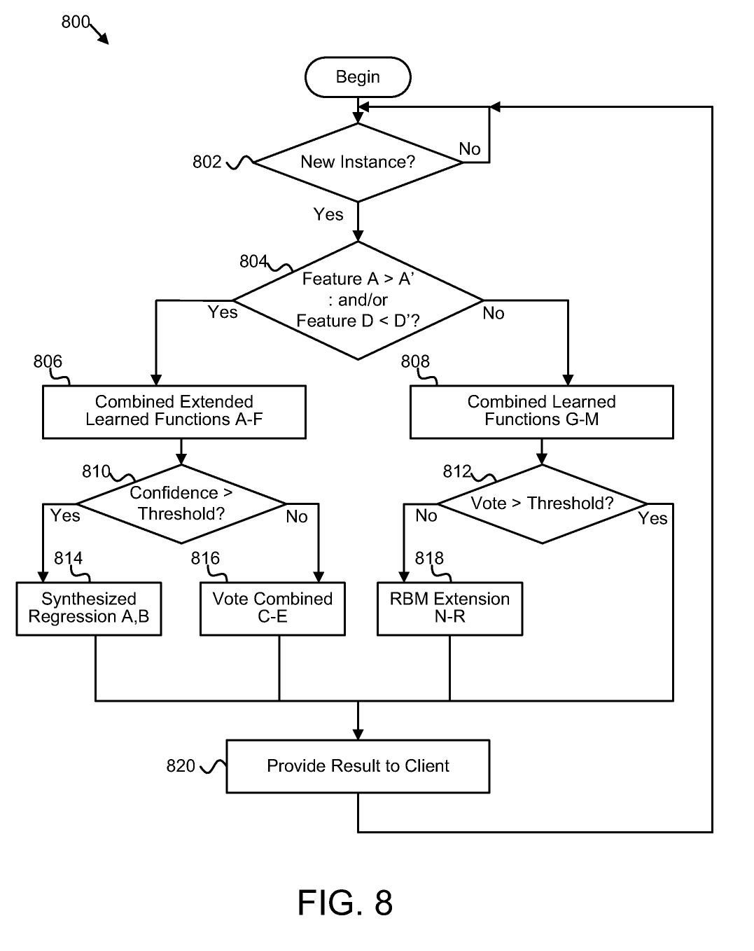

In the depicted embodiment, the machine learning ensemble 222 includes an orchestration module 320. The orchestration module 320, in certain embodiments, is configured to direct workload data through the machine learning ensemble 222 to produce a result, such as a classification, a confidence metric, an inferred function, a regression function, an answer, a recognized pattern, a rule, a threshold, a setting, a recommendation, and/or another result. In one embodiment, the orchestration module 320 uses evaluation metadata from the function evaluator module 312 and/or the metadata library 314, such as the synthesized metadata rule set 322, to determine how to direct workload data through the synthesized learned functions 324 of the machine learning ensemble 222. As described below with regard to FIG. 8, in certain embodiments, the synthesized metadata rule set 322 comprises a set of rules or conditions from the evaluation metadata of the metadata library 314 that indicate to the orchestration module 320 which features, instances, or the like should be directed to which synthesized learned function 324.

For example, the evaluation metadata from the metadata library 314 may indicate which learned functions were trained using which features and/or instances, how effective different learned functions were at making predictions based on different features and/or instances, or the like. The synthesizer module 310 may use that evaluation metadata to determine rules for the synthesized metadata rule set 322, indicating which features, which instances, or the like the orchestration module 320 the orchestration module 320 should direct through which learned functions, in which order, or the like. The synthesized metadata rule set 322, in one embodiment, may comprise a decision tree or other data structure comprising rules which the orchestration module 320 may follow to direct workload data through the synthesized learned functions 324 of the machine learning ensemble 222.

In one embodiment, the translation module 326 translates the output of the synthesized learned functions 324 into a rule, threshold, recommendation, configuration adjustment, incident management alert destination, or other result for the result module 206 to use. For example, in certain embodiments as described above, the synthesized learned functions 324 may provide a prediction, a classification, a confidence metric, an inferred function, a regression function, an answer, a subset of the instances, a subset of the one or more features, or the like as an output or result.

In certain embodiments, the synthesized learned functions 324 may not be configured to output a desired result, such as a rule, a threshold, a setting, a recommendation, a configuration adjustment, an incident management alert destination, or the like directly, and the translation module 326 may translate the output of one or more synthesized learned functions 324, one or more machine learning ensembles 322, or the like into a rule, threshold, recommendation, configuration adjustment, incident management alert destination, or other result with the result module 206 may use. The translation module 324 my programmatically translate or transform results according to a predefined schema or definition of a rule, setting, threshold, or policy of the systems management system 108.

For example, the translation module 326 may translate, configure, or modify one or more classifications and/or confidence metrics from the synthesized learned functions 324 into one or more first order predicate logic rule or another result, which the result module 206 may add to the systems management system 108. The translation module 326 may combine multiple results, results from multiple machine learning ensembles 222, or the like (e.g., multiple classifications, multiple confidence metrics, or other results) into a single rule, setting, threshold, policy, or the like for the systems management system 108. In other embodiments, the machine learning ensemble 222 and/or the synthesized learned functions 324 may be configured to output a desired result, such as a rule, a threshold, a setting, a recommendation, a configuration adjustment, an incident management alert destination, or the like directly for the result module 206, without a translation module 326.

FIG. 4 depicts one embodiment of a system 400 for an ensemble factory. The system 400, in the depicted embodiment, includes several clients 404 in communication with an interface module 402 either locally or over a data network 106. The ensemble factory module 212 of FIG. 4 is substantially similar to the ensemble factory module 212 of FIG. 3, but further includes an interface module 402 and a data repository 406.

The interface module 402, in certain embodiments, is configured to receive requests from clients 404, to provide results to a client 404, or the like. The learned function module 202, for example, may act as a client 404, requesting a machine learning ensemble 222 from the interface module 402 for use with data from the input module 202 or the like. The interface module 402 may provide a machine learning interface to clients 404, such as an API, a shared library, a hardware command interface, or the like, over which clients 404 may make requests and receive results. The interface module 402 may support new ensemble requests from clients 404, allowing clients to request generation of a new machine learning ensemble 222 from the ensemble factory module 212 or the like. As described above, a new ensemble request may include initialization data; one or more ensemble parameters; a feature, query, question or the like for which a client 404 would like a machine learning ensemble 222 to predict a result; or the like. The interface module 402 may support analysis requests for a result from a machine learning ensemble 222. As described above, an analysis request may include workload data; a feature, query, question or the like; a machine learning ensemble 222; or may include other analysis parameters.

In certain embodiments, the ensemble factory module 212 may maintain a library of generated machine learning ensembles 222, from which clients 404 may request results. In such embodiments, the interface module 402 may return a reference, pointer, or other identifier of the requested machine learning ensemble 222 to the requesting client 404, which the client 404 may use in analysis requests. In another embodiment, in response to the ensemble factory module 212 generating a machine learning ensemble 222 to satisfy a new ensemble request, the interface module 402 may return the actual machine learning ensemble 222 to the client 404, for the client 404 to manage, and the client 404 may include the machine learning ensemble 222 in each analysis request.

The interface module 402 may cooperate with the ensemble factory module 212 to service new ensemble requests, may cooperate with the machine learning ensemble 222 to provide a result to an analysis request, or the like. The ensemble factory module 212, in the depicted embodiment, includes the function generator module 301, the feature selector module 304, the predictive correlation module 318, and the machine learning compiler module 302, as described above. The ensemble factory module 212, in the depicted embodiment, also includes a data repository 406,

The data repository 406, in one embodiment, stores initialization data, so that the function generator module 301, the feature selector module 304, the predictive correlation module 318, and/or the machine learning compiler module 302 may access the initialization data to generate, combine, extend, evaluate, and/or synthesize learned functions and machine learning ensembles 222. The data repository 406 may provide initialization data indexed by feature, by instance, by training data subset, by test data subset, by new ensemble request, or the like. By maintaining initialization data in a data repository 406, in certain embodiments, the ensemble factory module 212 ensures that the initialization data is accessible throughout the machine learning ensemble 222 building process, for the function generator module 301 to generate learned functions, for the feature selector module 304 to determine which features should be used in the machine learning ensemble 222, for the predictive correlation module 318 to determine which features correlate with the highest confidence metrics, for the combiner module 306 to combine learned functions, for the extender module 308 to extend learned functions, for the function evaluator module 312 to evaluate learned functions, for the synthesizer module 310 to synthesize learned functions 324 and/or metadata rule sets 322, or the like.

In the depicted embodiment, the data receiver module 300 is integrated with the interface module 402, to receive initialization data, including training data and test data, from new ensemble requests. The data receiver module 300 stores initialization data in the data repository 406. The function generator module 301 is in communication with the data repository 406, in one embodiment, so that the function generator module 301 may generate learned functions based on training data sets from the data repository 406. The feature selector module 300 and/or the predictive correlation module 318, in certain embodiments, may cooperate with the function generator module 301 and/or the machine learning compiler module 302 to determine which features to use in the machine learning ensemble 222, which features are most predictive or correlate with the highest confidence metrics, or the like.

Within the machine learning compiler module 302, the combiner module 306, the extender module 308, and the synthesizer module 310 are each in communication with both the function generator module 301 and the function evaluator module 312. The function generator module 301, as described above, may generate an initial large amount of learned functions, from different classes or the like, which the function evaluator module 312 evaluates using test data sets from the data repository 406. The combiner module 306 may combine different learned functions from the function generator module 301 to form combined learned functions, which the function evaluator module 312 evaluates using test data from the data repository 406. The combiner module 306 may also request additional learned functions from the function generator module 301.

The extender module 308, in one embodiment, extends learned functions from the function generator module 301 and/or the combiner module 306. The extender module 308 may also request additional learned functions from the function generator module 301. The function evaluator module 312 evaluates the extended learned functions using test data sets from the data repository 406. The synthesizer module 310 organizes, combines, or otherwise synthesizes learned functions from the function generator module 301, the combiner module 306, and/or the extender module 308 into synthesized learned functions 324 for the machine learning ensemble 222. The function evaluator module 312 evaluates the synthesized learned functions 324, and the synthesizer module 310 organizes or synthesizes the evaluation metadata from the metadata library 314 into a synthesized metadata rule set 322 for the synthesized learned functions 324.

As described above, as the function evaluator module 312 evaluates learned functions from the function generator module 301, the combiner module 306, the extender module 308, and/or the synthesizer module 310, the function evaluator module 312 generates evaluation metadata for the learned functions and stores the evaluation metadata in the metadata library 314. In the depicted embodiment, in response to an evaluation by the function evaluator module 312, the function selector module 316 selects one or more learned functions based on evaluation metadata from the metadata library 314. For example, the function selector module 316 may select learned functions for the combiner module 306 to combine, for the extender module 308 to extend, for the synthesizer module 310 to synthesize, or the like.

FIG. 5 depicts one embodiment 500 of learned functions 502, 504, 506 for a machine learning ensemble 222. The learned functions 502, 504, 506 are presented by way of example, and in other embodiments, other types and combinations of learned functions may be used, as described above. Further, in other embodiments, the machine learning ensemble 222 may include an orchestration module 320, a synthesized metadata rule set 322, or the like. In one embodiment, the function generator module 301 generates the learned functions 502. The learned functions 502, in the depicted embodiment, include various collections of selected learned functions 502 from different classes including a collection of decision trees 502a, configured to receive or process a subset A-F of the feature set of the machine learning ensemble 222, a collection of support vector machines (“SVMs”) 502b with certain kernels and with an input space configured with particular subsets of the feature set G-L, and a selected group of regression models 502c, here depicted as a suite of single layer (“SL”) neural nets trained on certain feature sets K-N.

The example combined learned functions 504, combined by the combiner module 306 or the like, include various instances of forests of decision trees 504a configured to receive or process features N-S, a collection of combined trees with support vector machine decision nodes 504b with specific kernels, their parameters and the features used to define the input space of features T-U, as well as combined functions 504c in the form of trees with a regression decision at the root and linear, tree node decisions at the leaves, configured to receive or process features L-R.

Component class extended learned functions 506, extended by the extender module 308 or the like, include a set of extended functions such as a forest of trees 506a with tree decisions at the roots and various margin classifiers along the branches, which have been extended with a layer of Boltzman type Bayesian probabilistic classifiers. Extended learned function 506b includes a tree with various regression decisions at the roots, a combination of standard tree 504b and regression decision tree 504c and the branches are extended by a Bayes classifier layer trained with a particular training set exclusive of those used to train the nodes.

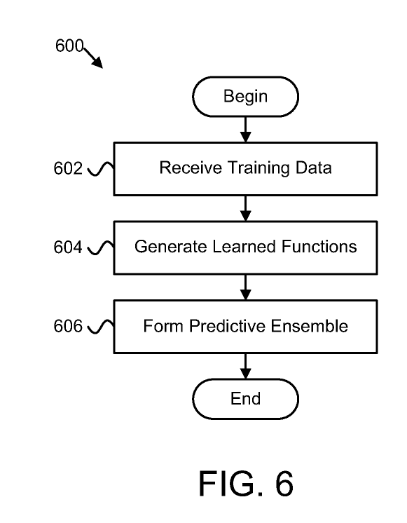

FIG. 6 depicts one embodiment of a method 600 for an ensemble factory. The method 600 begins, and the data receiver module 300 receives 602 training data. The function generator module 301 generates 604 a plurality of learned functions from multiple classes based on the received 602 training data. The machine learning compiler module 302 forms 606 a machine learning ensemble comprising a subset of learned functions from at least two classes, and the method 600 ends.

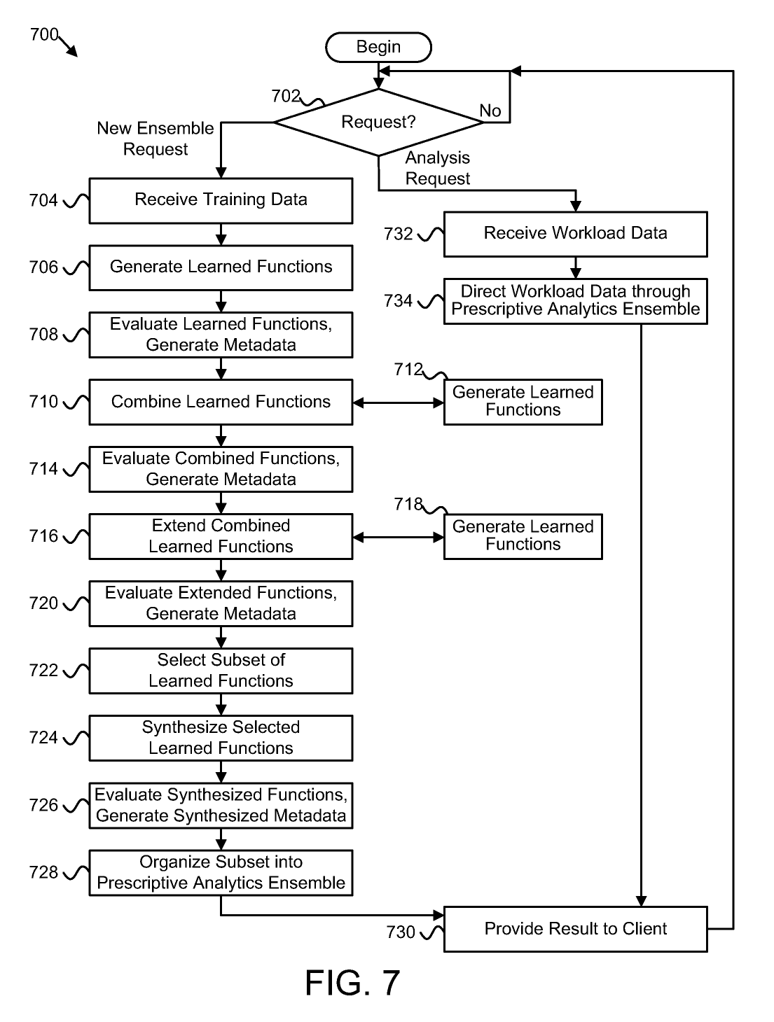

FIG. 7 depicts another embodiment of a method 700 for an ensemble factory. The method 700 begins, and the interface module 402 monitors 702 requests until the interface module 402 receives 702 an analytics request from a client 404 or the like.

If the interface module 402 receives 702 a new ensemble request, the data receiver module 300 receives 704 training data for the new ensemble, as initialization data or the like. The function generator module 301 generates 706 a plurality of learned functions based on the received 704 training data, from different machine learning classes. The function evaluator module 312 evaluates 708 the plurality of generated 706 learned functions to generate evaluation metadata. The combiner module 306 combines 710 learned functions based on the metadata from the evaluation 708. The combiner module 306 may request that the function generator module 301 generate 712 additional learned functions for the combiner module 306 to combine.

The function evaluator module 312 evaluates 714 the combined 710 learned functions and generates additional evaluation metadata. The extender module 308 extends 716 one or more learned functions by adding one or more layers to the one or more learned functions, such as a probabilistic model layer or the like. In certain embodiments, the extender module 308 extends 716 combined 710 learned functions based on the evaluation 712 of the combined learned functions. The extender module 308 may request that the function generator module 301 generate 718 additional learned functions for the extender module 308 to extend. The function evaluator module 312 evaluates 720 the extended 716 learned functions. The function selector module 316 selects 722 at least two learned functions, such as the generated 706 learned functions, the combined 710 learned functions, the extended 716 learned functions, or the like, based on evaluation metadata from one or more of the evaluations 708, 714, 720.

The synthesizer module 310 synthesizes 724 the selected 722 learned functions into synthesized learned functions 324. The function evaluator module 312 evaluates 726 the synthesized learned functions 324 to generate a synthesized metadata rule set 322. The synthesizer module 310 organizes 728 the synthesized 724 learned functions 324 and the synthesized metadata rule set 322 into a machine learning ensemble 222. The interface module 402 provides 730 a result to the requesting client 404, such as the machine learning ensemble 222, a reference to the machine learning ensemble 222, an acknowledgment, or the like, and the interface module 402 continues to monitor 702 requests.

If the interface module 402 receives 702 an analysis request, the data receiver module 300 receives 732 workload data associated with the analysis request. The orchestration module 320 directs 734 the workload data through a machine learning ensemble 222 associated with the received 702 analysis request to produce a result, such as a classification, a confidence metric, an inferred function, a regression function, an answer, a recognized pattern, a rule, a threshold, a setting, a recommendation, and/or another result. The interface module 402 provides 730 the produced result to the requesting client 404, and the interface module 402 continues to monitor 702 requests.

FIG. 8 depicts one embodiment of a method 800 for directing data through a machine learning ensemble. The specific synthesized metadata rule set 322 of the depicted method 800 is presented by way of example only, and many other rules and rule sets may be used.

A new instance of workload data is presented 802 to the machine learning ensemble 222 through the interface module 402. The data is processed through the data receiver module 300 and configured for the particular analysis request as initiated by a client 404. In this embodiment the orchestration module 320 evaluates a certain set of features associates with the data instance against a set of thresholds contained within the synthesized metadata rule set 322.

A binary decision 804 passes the instance to, in one case, a certain combined and extended function 806 configured for features A-F or in the other case a different, parallel combined function 808 configured to predict against a feature set G-M. In the first case 806, if the output confidence passes 810 a certain threshold as given by the meta-data rule set the instance is passed to a synthesized, extended regression function 814 for final evaluation, else the instance is passed to a combined collection 816 whose output is a weighted voted based processing a certain set of features. In the second case 808 a different combined function 812 with a simple vote output results in the instance being evaluated by a set of base learned functions extended by a Boltzman type extension 818 or, if a prescribed threshold is meet the output of the synthesized function is the simple vote. The interface module 402 provides 820 the result of the orchestration module directing workload data through the machine learning ensemble 222 to a requesting client 404 and the method 800 continues.

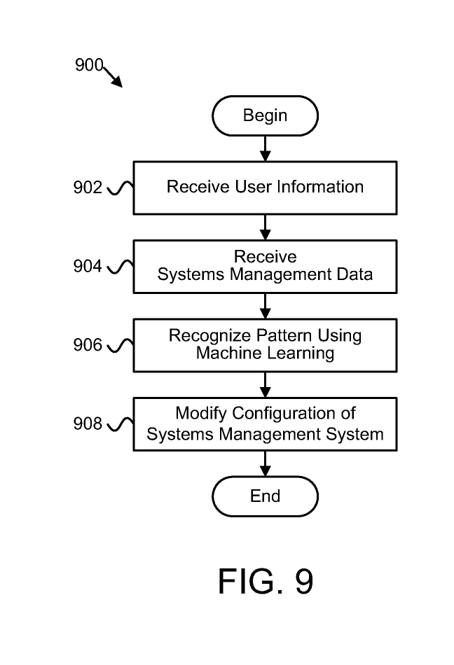

FIG. 9 depicts one embodiment of a method 900 for modifying a systems management system 108. The method 900 begins and the input module 202 receives 902 user information and receives 904 systems management data. The received 902 user information, in certain embodiments, labels or identifies a state of one or more computing systems 104 or other computing resources. In another embodiment, the received 902 user information may comprise an identification of a business activity, a set of user classifications for a performance metric of a business activity, or the like.

The learned function module 204, such as a machine learning ensemble or the like, recognizes 906 a pattern in the received 904 systems management data, using machine learning. The result module 206 modifies 908 a configuration of the systems management system 108 based on the state labeled or identified by the received 902 user information and based on the recognized 906 pattern and the method 900 ends. In one embodiment, the result module 206 modifies 908 the configuration of the systems management system 108 by decomposing a received 902 business activity or set of user classifications into a plurality of rules for the systems management system 108 based on the recognized 906 pattern.

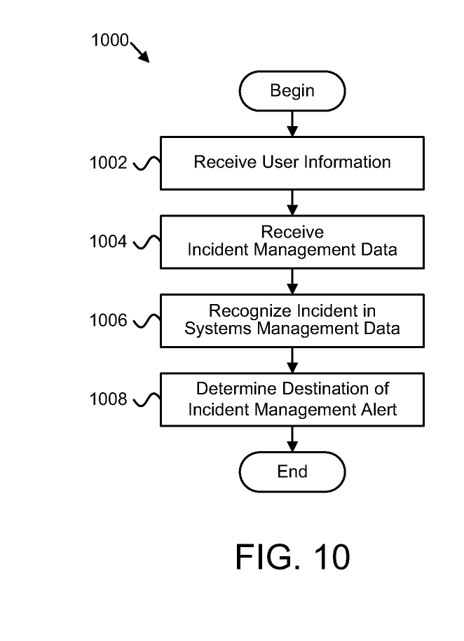

FIG. 10 depicts one embodiment of a method 1000 for modifying an incident management system. The method 1000 begins and the input module 202 receives 1002 user information and receives 1004 incident management data. The received 1002 user information, in certain embodiments, identifies a state of one or more computing systems 104 or other computing resources. The learned function module 204, the incident management module 226, and/or the incident management prediction module 228, using a machine learning ensemble or the like, recognizes 1006 an incident in the received 1004 systems management data. The result module 206, in cooperation with the learned function module 204, a machine learning ensemble, or the like, determines 1008 a destination for an incident management alert based on a pattern identified in the received 1004 incident management data using machine learning and the method 1000 ends.

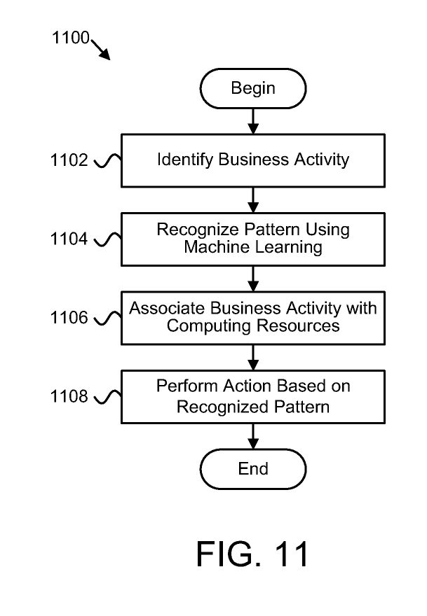

FIG. 11 depicts one embodiment of a method 1100 for systems management. The method 1100 begins and the input module 202 identifies 1102 a business activity based on input from a user 110. The learned function module 204, such as a machine learning ensemble or the like, recognizes 1104 one or more patterns, using machine learning, in systems management data for a plurality of computing systems 104 or other computing resources.

The learned function module 204 associates 1106 the identified 1102 business activity with one or more of the plurality of computing systems 104 or other computing resources, using machine learning, based on the recognized 1104 one or more patterns. In certain embodiments, the result module 206 may perform 1108 an action based on the recognized 1104 one or more patterns and the method 1100 ends. For example, in one embodiment, the result module 206 may modify a systems management system 108 associated with the plurality of computing systems 104 or other computing resources based on the recognized 1104 one or more patterns. In another embodiment, the result module 206 may provide a capacity projection for at least one of the plurality of computing systems 104 or other computing resources based on the recognized 1104 one or more patterns, such as an estimate of an effect of adjusting a capacity, a prediction of an incident associated with a capacity, or the like.

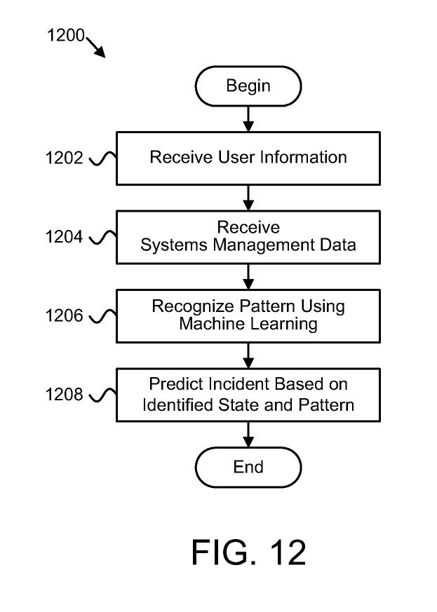

FIG. 12 is a schematic flow chart diagram illustrating one embodiment of a method 1200 for modifying a systems management system 108. The method 1200 begins and the input module 202 receives 1202 user information and receives 1204 systems management data. The received 1202 user information, in certain embodiments, labels or identifies a state of one or more computing systems 104 or other computing resources. In another embodiment, the received 1202 user information may comprise an identification of a business activity, a set of user classifications for a performance metric of a business activity, or the like.

The learned function module 204, such as a machine learning ensemble or the like, recognizes 1206 a pattern in the received 1204 systems management data, using machine learning. The result module 206, in cooperation with the learned function module 204, a machine learning ensemble, or the like, predicts 1208 an incident for one or more computing systems 104 or other computing resources based on the state identified by the received 1202 user information and based on the recognized 1206 pattern and the method 1200 ends.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A method for systems management, the method comprising:
receiving user information and systems management data as machine learning inputs, the user information labeling a state of one or more computing resources;
recognizing a pattern, using machine learning, in the systems management data; and
modifying a configuration of a systems management system based on the labeled state and the recognized pattern.

2. The method of claim 1, wherein modifying the configuration of the systems management system comprises one or more of adding a rule, removing a rule, modifying an existing rule, setting a threshold, and intercepting an alert from the systems management system.

3. The method of claim 1, further comprising limiting an amount of modifications to the configuration of the systems management system such that the amount of modifications satisfies a performance threshold.

4. The method of claim 1, wherein the user information comprises an indication of whether an alert from the systems management system accurately identifies the state of the one or more computing resources.

5. The method of claim 1, wherein the user information comprises a set of user classifications labeling one or more values of a performance metric for a business activity, the set of user classifications labeling the state of the one or more computing resources.

6. The method of claim 1, wherein the machine learning comprises a machine learning ensemble comprising a plurality of learned functions from multiple classes, the plurality of learned functions selected from a larger plurality of generated learned functions.

7. The method of claim 1, wherein the systems management data comprises one or more of application log data, a monitored hardware statistic, a processor usage metric, a volatile memory usage metric, a storage device metric, a performance metric for a business activity, an identifier of an executing thread, a network event, a network metric, a transaction duration, a user sentiment indicator, and a weather status for a geographic area of the one or more computing resources.

8. A computer program product comprising a computer readable storage medium storing computer usable program code executable to perform operations for systems management, the operations comprising:
receiving user information and incident management data as machine learning inputs, the user information labeling a state of one or more computing resources;
recognizing an incident in systems management data for the one or more computing resources based on the user information; and
determining a destination for an incident management alert based on a pattern identified in the incident management data using machine learning.

9. The computer program product of claim 8, wherein the incident management data comprises a history of incident management alert destinations and incident outcomes.

10. The computer program product of claim 8, wherein the operations further comprise monitoring subsequent incident management data, using the machine learning, and determining a different destination for a subsequent incident management alert for a similar incident based on the subsequent incident management data.

11. The computer program product of claim 8, wherein the machine learning comprises a machine learning ensemble comprising a plurality of learned functions from multiple classes, the plurality of learned functions selected from a larger plurality of pseudo-randomly generated learned functions.

12. An apparatus for systems management, the apparatus comprising:
an input module configured to receive systems management data;
a machine learning ensemble comprising a plurality of learned functions from multiple classes, the plurality of learned functions selected from a larger plurality of generated learned functions, the machine learning ensemble configured to recognize a pattern in the systems management data; and
a result module configured to modify a configuration of a systems management system based on the recognized pattern.

13. The apparatus of claim 12, further comprising an ensemble factory module configured to form the machine learning ensemble, the ensemble factory module configured to generate the larger plurality of generated learned functions using training systems management data and to select the plurality of learned functions based on an evaluation of the larger plurality of learned functions using test systems management data.

14. The apparatus of claim 13, wherein the ensemble factory module is further configured to one or more of:
combine multiple learned functions from the larger plurality of generated learned functions to form a combined learned function for the plurality of learned functions of the machine learning ensemble; and
add one or more layers to at least a portion of the larger plurality of generated learned functions to form one or more extended learned functions for the plurality of learned functions of the machine learning ensemble.

15. The apparatus of claim 12, further comprising one or more additional machine learning ensembles, each machine learning ensemble associated with a different set of one or more rules of the systems management system.

16. A method for systems management, the method comprising:
identifying a business activity based on input from a user;
recognizing one or more patterns, using machine learning, in systems management data for a plurality of computing resources; and
associating the identified business activity with one or more of the computing resources, using machine learning, based on the recognized one or more patterns.

17. The method of claim 16, further comprising modifying a systems management system based on the one or more recognized patterns, the systems management system associated with the plurality of computing resources.

18. The method of claim 16, further comprising providing a capacity projection for at least one of the plurality of computing resources based on the recognized one or more patterns.

19. The method of claim 18, wherein the capacity projection comprises an estimate of an effect of adjusting a capacity of the at least one computing resource.

20. The method of claim 18, wherein the capacity projection comprises a prediction of an incident associated with a capacity of the at least one computing resource.

21. The method of claim 16, further comprising monitoring the systems management data and a performance metric associated with the business activity, using the machine learning, to recognize one or more additional patterns associated with the identified business activity.

22. The method of claim 16, wherein the input from the user comprises a set of classifications for a performance metric associated with the business activity.

23. The method of claim 22, wherein each classification in the set labels one or more possible values of the performance metric for the business activity.

24. The method of claim 22, wherein the performance metric comprises one or more of an amount of time to complete the business activity and a volume of transactions associated with the business activity.

25. A computer program product comprising a computer readable storage medium storing computer usable program code executable to perform operations for systems management, the operations comprising:
receiving user information and systems management data as machine learning inputs, the user information identifying a state of one or more computing resources;
recognizing a pattern, using machine learning, in the systems management data; and
predicting an incident for the one or more computing resources based on the identified state and the recognized pattern.

26. The computer program product of claim 25, the operations further comprising determining a destination for an incident management alert for the predicted incident based on historical incident management data.

27. The computer program product of claim 25, the operations further comprising modifying a configuration of a systems management system based on the predicted incident.

28. The computer program product of claim 25, wherein the pattern comprises a precursor state for the incident.

29. The computer program product of claim 25, wherein the user information identifies which of the one or more computing resources are associated with an identified business transaction.

30. The computer program product of claim 25, wherein the machine learning comprises a machine learning ensemble comprising a plurality of learned functions from multiple classes, the plurality of learned functions selected from a larger plurality of generated learned functions.
